(19) United States
(12) Patent Application Publication
(10) Pub. No.: US 2025/0208971 A1
(43) Pub. Date: Jun. 26, 2025

(54) ADAPTIVE CONTENT GENERATION SYSTEMS USING SEED IMAGES

(71) Applicant: EXPEDITION TRAVEL ADVISORY, INC., Kirkland, WA (US)

(72) Inventors: Peter Leeds Bryant, Bellevue, WA (US); Richard J. McAniff, Aspen, CO (US)

(21) Appl. No.: 18/991,002

(22) Filed: Dec. 20, 2024

Related U.S. Application Data
(60) Provisional application No. 63/674,753, filed on Jul. 23, 2024.
(60) Provisional application No. 63/613,294, filed on Dec. 21, 2023.

(51) Int. Cl. G06F 11/34; G06F 16/29; G06Q 50/14

(52) U.S. Cl. CPC G06F 11/3438; G06F 16/29; G06Q 50/14

(57) ABSTRACT

The system and methods described herein also define a general approach to develop a unique user preference profile from a single “seed” video, or image. The system and methods in the presented implementations utilize internal algorithms, machine learning platforms, and knowledge of an itinerary schema to define user preferences and match with recommended travel locations. The system and methods extract metadata information of the seed video (e.g., geographical location, geotags) and detect user interaction with the platform presentation of the seed video to create a user preference profile. As the user continues interacting with the presented seed video, the platform will continuously adjust the user preference profile to accurately reflect user travel priorities and interests. Accordingly, the system uses the user preference profile to generate personalized travel recommendations.

### CROSS-REFERENCE TO RELATED APPLICATION(S)

This application claims benefit to U.S. Provisional Application No. 63/613,294 filed on Dec. 21, 2023 and U.S. Provisional Application No. 63/674,753 filed on Jul. 23, 2024, the contents all of which are incorporated by reference herein as though set forth in their entirety, and to which priority and benefit are claimed.

### TECHNICAL FIELD

The systems, methods, and computer-readable media disclosed herein relate generally to systems and methods for generating a set/series of images/digital content based on one or more seed digital content (e.g., image, video, audio, etc.) and/or associated metadata. The systems and methods identify a location associated with the seed digital content and use machine learning algorithms to identify a set/series of digital content that matches the seed digital content and meets one or more matching criterion. Some aspects of the location identification and matching platforms disclosed herein relate to the generation of location profiles as a measure of similarity to other travel locations. Measuring location profile similarity enables identification of compatible locations to the original location.

BACKGROUND

In 2018, the total amount of data created, captured, copied and consumed in the world was 33 zettabytes (ZB)—the equivalent of 33 trillion gigabytes. This grew to 59ZB in 2020 and is predicted to reach 175ZB by 2025. As the volume of digital content continues to grow at an exponential rate, existing systems that are designed to find comparable content struggle to keep up. For example, existing systems take an extraordinary amount of time to identify content that is similar to each other. And even then, the results may be suboptimal because the systems are designed to satisfy generic constraints and are unable to account for individualized or customized preferences, without requiring significant user input and customization/fine-tuning.

As an example, existing travel metasearch systems are configured to present users with a set of recommended travel locations, events, or activities based on input user query. The systems are designed to optimize user recommendations based on quantitative (e.g., price, distance) and qualitative (e.g., location) criteria. These systems often also provide discrete filters that enable users to manually adjust recommendation results based on their individual travel preferences. For example, if a user seeks recommendations that are below a certain price point, the user can apply a maximum price limit or filter. Advanced systems may also provide travel recommendations based on previous travel locations or ratings from other users. However, these systems often struggle in recognizing individual user preferences when generating travel suggestions without significant manual input and interaction from the end user.

A large language model (LLM) is a language model notable for its ability to achieve general-purpose language understanding and generation. LLMs acquire these abilities by learning statistical relationships from text documents during a computationally intensive self-supervised and semi-supervised training process. LLMs can be used for text generation, a form of generative artificial intelligence (GenAI), by taking an input text and repeatedly predicting the next token or word. Generative artificial intelligence (AI) is a machine learning paradigm capable of generating text, images, videos, or other data using generative models, often in response to prompts. Generative machine learning models learn the patterns and structure of their input training data and then generate new data that has similar characteristics.

### BRIEF DESCRIPTION OF THE DRAWINGS

Detailed descriptions of implementations of the present invention will be described and explained through the use of the accompanying drawings.

FIG. 1 is a system diagram illustrating an example of a computing environment in which the disclosed system operates in some implementations.

FIG. 2 is a block diagram that illustrates an interactive signal processing system that can implement aspects of the present technology.

FIG. 3 is a block diagram that illustrates example user interface components of the interactive signal processing system in accordance with some implementations of the present technology.

FIG. 4 is a block diagram that illustrates an example process of transforming monitored user actions in accordance with some implementations of the present technology.

FIGS. 5A-5B is a block diagram that illustrates examples of user action detection mechanisms in accordance with some implementations of the present technology.

FIG. 6 is a block diagram showing some of the components typically incorporated in generating unique preference vectors in accordance with some implementations of the present technology.

FIG. 7 is a block diagram that illustrates a dialogue generation process in accordance with some implementations of the present technology.

FIG. 8 is a block diagram that illustrates examples of user-interactable interface elements in accordance with some implementations of the present technology.

FIG. 9 is a flowchart that illustrates a process for determining custom geographic location recommendations in accordance with some implementations of the present technology.

FIG. 10 is a flowchart that illustrates a process for determining custom points of interest (POIs) in accordance with some implementations of the present technology.

FIG. 11 illustrates a layered architecture of an artificial intelligence (AI) system that can implement the ML models of the interactive signal processing system in accordance with some implementations of the present technology.

FIG. 12 is a block diagram of an example transformer that can implement aspects of the present technology.

FIG. 13 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

To overcome these and other drawbacks of existing systems, the present document discloses systems and methods of generating custom itemized data schemas that are dynamically personalized to observed user preferences and interactive actions. For example, the disclosed system can generate one or more itinerary recommendations (e.g., locations, activities, events, and/or points of interest (POI) near a target location) based on ordered sequences of interactive signals (e.g., turn-based conversational dialogues) between users (e.g., individual participants, collaborative user groups, and/or the like) and a generative communications agent (also referred to as “generative agent”). The ordered sequences of interactive signals can be analyzed to adaptively capture (e.g., via dynamic quantitative weights) user preference information (e.g., stored user profiles, user preference vectors, and/or the like), which enables recommendation of specific itinerary items that maximize user engagement.

The system and methods described herein define an adaptive solution for identifying personalized points of interest for users planning a travel itinerary. The system and methods in the presented implementations utilize internal algorithms, machine learning systems, and knowledge of a schema (e.g., an itinerary schema in a travel use case example) to define user preferences and match with recommended travel locations. The system and methods identify location metadata and relevant contextual dialogue between a user and the system to align recommendation responses to observed user preferences. As the user continues interacting with the presented dialogue, the system will continuously adjust the user preference profile to accurately reflect user travel priorities and interests. Accordingly, the system uses the user preference profile to generate personalized travel recommendations.

In a travel portal use case example, generating personalized travel recommendations for a user requires knowledge of common user interests across several travel locations, venues, and/or events. Accordingly, further described herein is a generative recommendation agent that adapts to unique user profiles and further refines its results based on continued interactions with the user. The system uses user profiles and prior dialogue histories to identify relevant context information for guiding recommendations by the generative agent. Although the systems and methods discussed herein are illustrated under the context of generating personalized travel itineraries, a person reasonably skilled in the art will appreciate that the described novel features and aspects are further applicable to general planning and recommendation solutions.

For illustrative purposes, some examples of systems and methods are described herein in the context of generating adaptive itinerary recommendations (e.g., a geographic location, a travel point of interest, an participating event, and/or the like) via monitoring user interactive actions with respect to a passive (e.g., a viewing of a seed video) and/or an active (e.g., engagement in conversational dialogue with virtual agent) stimuli. However, a person skilled in the art will appreciate that the disclosed system can be applied in other contexts. As an example, the disclosed system can be used within computing systems for generating custom itemized data schemas (e.g., a runtime process configuration) based on user-specific needs and/or preferences.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Example Computing Environment

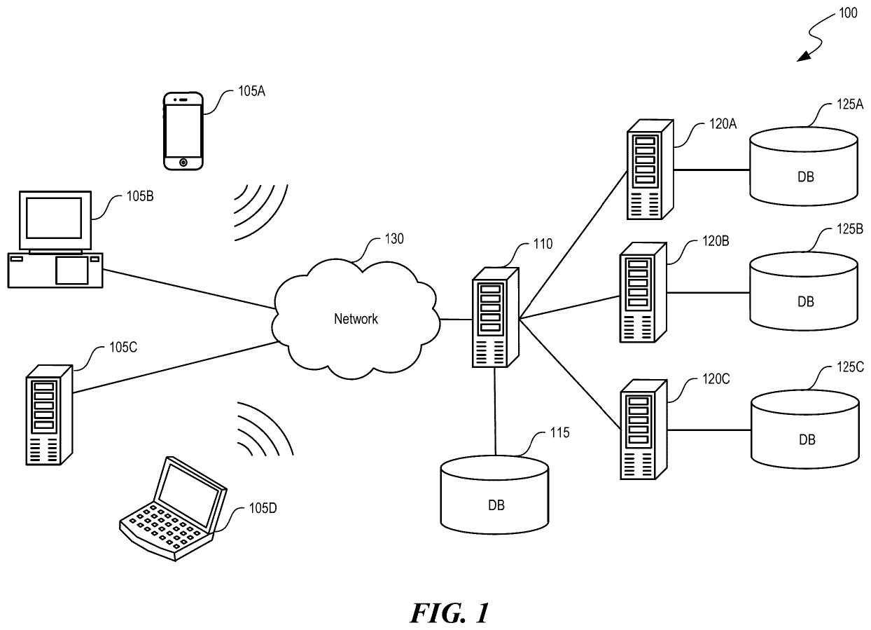

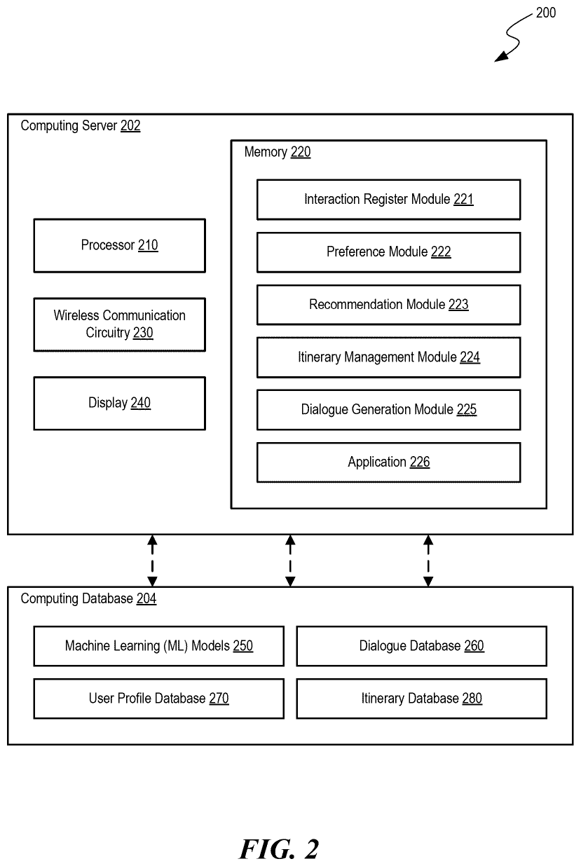

FIG. 1 is a system diagram illustrating an example of a computing environment in which the disclosed system operates in some implementations. In some implementations, environment 100 includes one or more client computing devices 105A-D, examples of which can host the interactive signal processing system 200 of FIG. 2. Client computing devices 105 operate in a networked environment using logical connections through network 130 to one or more remote computers, such as a server computing device.

In some implementations, server 110 is an edge server which receives client requests and coordinates fulfillment of those requests through other servers, such as servers 120A-C. In some implementations, server computing devices 110 and 120 comprise computing systems, such as the interactive signal processing system 200 of FIG. 2. Though each server computing device 110 and 120 is displayed logically as a single server, server computing devices can each be a distributed computing environment encompassing multiple computing devices located at the same or at geographically disparate physical locations. In some implementations, each server 120 corresponds to a group of servers.

Client computing devices 105 and server computing devices 110 and 120 can each act as a server or client to other server or client devices. In some implementations, servers (110, 120A-C) connect to a corresponding database (115, 125A-C). As discussed above, each server 120 can correspond to a group of servers, and each of these servers can share a database or can have its own database. Databases 115 and 125 warehouse (e.g., store) information such as claims data, email data, call transcripts, call logs, policy data and so on. Though databases 115 and 125 are displayed logically as single units, databases 115 and 125 can each be a distributed computing environment encompassing multiple computing devices, can be located within their corresponding server, or can be located at the same or at geographically disparate physical locations.

Network 130 can be a local area network (LAN) or a wide area network (WAN), but can also be other wired or wireless networks. In some implementations, network 130 is the Internet or some other public or private network. Client computing devices 105 are connected to network 130 through a network interface, such as by wired or wireless communication. While the connections between server 110 and servers 120 are shown as separate connections, these connections can be any kind of local, wide area, wired, or wireless network, including network 130 or a separate public or private network.

### Interactive Signal Processing System

FIG. 2 is a block diagram that illustrates an itinerary recommendation system 200 (“system 200”) that can implement aspects of the present technology. The components shown in FIG. 2 are merely illustrative, and well-known components are omitted for brevity. As shown, the computing server 202 includes a processor 210, a memory 220, a wireless communication circuitry 230 to establish wireless communication and/or information channels (e.g., Wi-Fi, internet, APIs, communication standards) with other computing devices and/or services (e.g., servers, databases, cloud infrastructure), and a display 240 (e.g., user interface). The processor 210 can have generic characteristics similar to general-purpose processors, or the processor 210 can be an application-specific integrated circuit (ASIC) that provides arithmetic and control functions to the computing server 202. While not shown, the processor 210 can include a dedicated cache memory. The processor 210 can be coupled to all components of the computing server 202, either directly or indirectly, for data communication. Further, the processor 210 of the computing server 202 can be communicatively coupled to a computing database 204 that is hosted alongside the computing server 202 on the core network 130 described in reference to FIG. 1. As shown, the computing database 204 can include a machine learning models (ML) 250 database, a dialogue database 260, a user profile database 270, and an itinerary database 280.

The memory 220 can comprise any suitable type of storage device including, for example, a static random-access memory (SRAM), dynamic random-access memory (DRAM), electrically erasable programmable read-only memory (EEPROM), flash memory, latches, and/or registers. In addition to storing instructions that can be executed by the processor 210, the memory 220 can also store data generated by the processor 210 (e.g., when executing the modules of an optimization system). In additional, or alternative, embodiments, the processor 210 can store temporary information onto the memory 220 and store long-term data onto the computing database 204. The memory 220 is merely an abstract representation of a storage environment. Hence, in some embodiments, the memory 220 comprises one or more actual memory chips or modules.

As shown in FIG. 2, modules of the memory 220 can include an interaction register module 221, a preference module 222, a recommendation module 223, an itinerary management module 224, a dialogue generation module 225, and an application 226. Other implementations of the computing server 202 include additional, fewer, or different modules, or distribute functionality differently between the modules. As used herein, the term “module” refers broadly to software components, firmware components, and/or hardware components. Accordingly, the modules 221, 222, 223, 224, 225, 226 could each comprise software, firmware, and/or hardware components implemented in, or accessible to, the computing server 202.

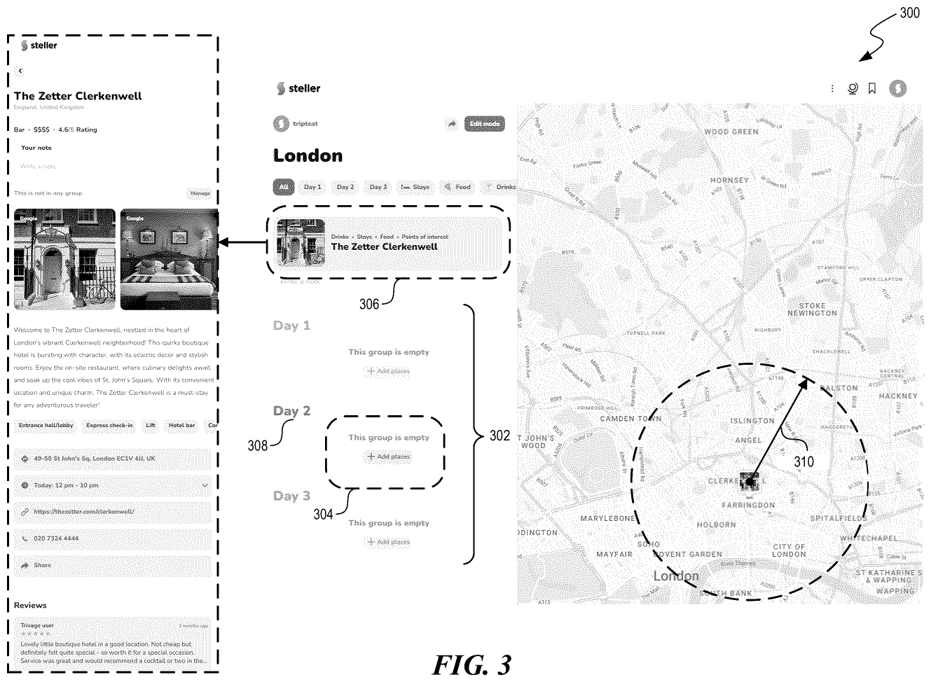

FIG. 3 is a block diagram that illustrates example user interface components 300 (“interface 300”) of the interactive signal processing system 200 (“system 200”) in accordance with some implementations of the present technology. Furthermore, FIG. 3 illustrates examples of the interactive signal processing system 200 generating a structure 302 (e.g., an itemized sequence, a timeline, and/or the like) of travel item placeholders 304 for an itinerary of travel locations and presenting recommended travel items 306 based on the seed video to assign a travel item placeholder. For example, the interactive signal processing system 200 can generate an itinerary of locations for the end user by developing a structure 302 of item placeholders 304 representing empty spaces within the itinerary that requires substitution by user selected travel items. In some implementations, the system 200 can dynamically organize (e.g., reorder) the item placeholders 304 of the structure 302. As an example, the system 200 can group the item placeholders 304 within the structure 302 based on assigned travel item categories 308 such as dining location, stay location, point of interest, days of the week, time at an activity, transportation, and/or any combination thereof. In another example, the system 200 can order the item placeholders 304 within the structure 302 based on assigned priorities of travel item categories 308 (e.g., predetermined item category 308 order). In another example, the system 200 can order the item placeholders 304 based on historical user preferences (e.g., previous user sequence of item placeholders 304) and/or predicted user priorities (e.g., estimated item category 308 order using user preference vectors) associated with travel item categories 308. In another example, the system 200 can order the item placeholders 304 for a current user based on preferences and/or priorities of other users (e.g., social friends, popular profiles, community members, interest groups, and/or the like) that are associated with the current user.

In some implementations, the system 200 can dynamically reorder the item placeholders 304 in response to user activities and/or interactions with the interface 300 of the system 200. As an illustrative example, the system 200 can respond to user selection, or assignment, of a travel item (e.g., a geographic location, a point of interest, a scheduled activity, and/or the like) for an item placeholder 304 by updating the sequential position of the item placeholder 304 (e.g., or the travel item) within the structure 302 such that the item placeholders 304 of the structure 302 are in chronological order (e.g., time of day, day of the week, and/or the like) of the travel items. In another example, the system 200 can update the sequential position of the item placeholder 304 (e.g., or the travel item) such that the sequential arrangement of item placeholders 304 maximizes user configuration options (e.g., available travel items for remaining item placeholders 304) with respect to one or more accessibility constraints (e.g., event schedules, reservation dates, operating hours, and/or the like) associated with assigned travel items. In another example, the system 200 can update the sequential position of the item placeholder 304 (e.g., or the travel item) such that the sequential arrangement of item placeholders 304 minimizes the individual and/or cumulative costs (e.g., travel duration, distance, financial expenditures, and/or the like) of transitioning between travel items. In other implementations, the system 200 can dynamically reorder the item placeholders 304 according to a combination of arrangement priorities (e.g., minimization of cumulative costs and maximization of user configuration options, and/or the like). In additional or alternative implementations, the system 200 can use statistical optimization algorithms (e.g., computational solvers for the Travelling Salesman Problem (TSP)) to determine one or more sequential arrangements of the item placeholders 304 for the structure 302.

The interactive signal processing system 200 of FIG. 2 can use the recommendation module 223 to iteratively fill and/or replace each travel item placeholder 304 using user preference vectors, object preference vectors, metadata information, active user interaction data, and/or any combination thereof. For example, the interactive signal processing system 200 can use the recommendation module 223 to generate a set of recommended geographic locations for the user to choose from. The recommendation module 223 identifies database objects with geographic locations that are within a specific distance 310 of the seed video location. In some implementations, the specific distance 310 can be defined as the viewport distance from the center of the seed video location. In other implementations, the interactive signal processing system 200 can also filter by geographic locations that fulfill the travel item placeholder categories 308.

In some implementations, the recommendation module 223 can generate the set of recommended geographic locations based on one or more predefined user preferences and/or search constraints (e.g., cumulative travel duration, distance, financial cost, real-time climate conditions, and/or the like). For example, the recommendation module 223 can identify database objects corresponding to geographic locations that comprise travel items (e.g., scheduled activities, points of interests, and/or the like) that do not exceed a user specified expenditure threshold (e.g., a maximum budget constraint). In other implementations, the recommendation module 223 can generate the set of recommended geographic locations based on communal reviews (e.g., quality ratings, narrative recommendations) corresponding to one or more other participant users. For example, the recommendation module 223 can filter for database objects with geographic locations (e.g., or travel items proximate to the geographic locations) that comprise a high communal review score (e.g., an aggregate quality score). In other implementations, the recommendation module 223 can generate the set of recommended geographic locations based on a thematic schema (e.g., a predefined itinerary structure and/or criteria). For example, the recommendation module 223 can use a predefined thematic schema for an athletic travel route to exclusively identify database objects with geographic locations and/or travel items that are associated with physically demanding activities (e.g., outdoor sports).

In some implementations, the recommendation module 223 can generate a set of recommended travel items based on the user preference vector. For example, the interactive signal processing system 200 can extract geographical information (e.g., geotags or geographic identifiers, Google Place ID) from the seed video metadata information. Accordingly, the interactive signal processing system 200 can use the preference module 222 to generate a seed preference vector for the seed video location based on text-based information. In some implementations, the interactive signal processing system 200 can use machine learning models, NLP systems, and/or generative machine learning systems to use texts or images associated with the geographic location as part of generating the preference vector.

In some implementations, the recommendation module 223 can generate a set of recommended geographic locations to the interactive signal processing system 200 based on the user preference vector and database object preference vectors. For example, the recommendation module 223 can compare the user and geographic object preference object vectors to identify geographic object preference vectors that are similar to the user preference vector. In additional or alternative implementations, the recommendation module 223 can use content information of the user profile, nearby locations, or featured items in the geographic location to adjust recommendations by modifying the user preference vector. In some implementations, the interactive signal processing system 200 can determine the similarity of preference vectors based on a similarity threshold calculated using cosine similarity and/or Euclidean distance. In other implementations, the similarity between preference vectors can be measured using machine learning models, NLP systems, and/or generative machine learning systems to produce similarity metrics.

In some implementations, the recommendation module 223 uses the user preference vectors of other users to generate the set of recommended geometric locations. For example, the recommendation module 223 uses user preference vectors of users with connections to the user to compare with preference vectors of database location objects and identifying recommended geographic locations. In some implementations, the recommendation module 223 can use preference vectors of geographic locations from trips created by other users in identifying recommended geographic locations. In some implementations, the recommendation module 223 can use preference vectors of geographic locations from trips that use the seed location to identify recommended geographic locations. In some implementations, the interactive signal processing system 200 can connect to the user via the user interface to notify the user that new recommended geographic locations were identified that satisfy the itinerary structure 302.

In some implementations, the interactive signal processing system 200 presents the recommended geographic locations to the user via user interface and use the interaction register module 221 to observe user interactions with the recommended locations. For example, the interactive signal processing system 200 uses the interaction register module 221 to identify user actions in response to the presented recommended locations (e.g., selecting a location, duration of inactivity). The interactive signal processing system 200 can use the interaction register module 221 to generate new user interaction vectors from detected user actions and the preference module 222 to update the user preference vector using the new user interaction vectors. In some implementations, the interactive signal processing system 200 can respond to user selection of a recommended location by associating one or more location placeholders 304 with the selected geographic location. Additionally, the interactive signal processing system 200 can iteratively loop through the above procedure until all placeholders 304 are exhausted (e.g., no remaining travel item placeholders). In other implementations, the interactive signal processing system 200 can prematurely exit the iterative process and complete the itinerary of locations by removing any remaining travel item placeholders without an associated travel item.

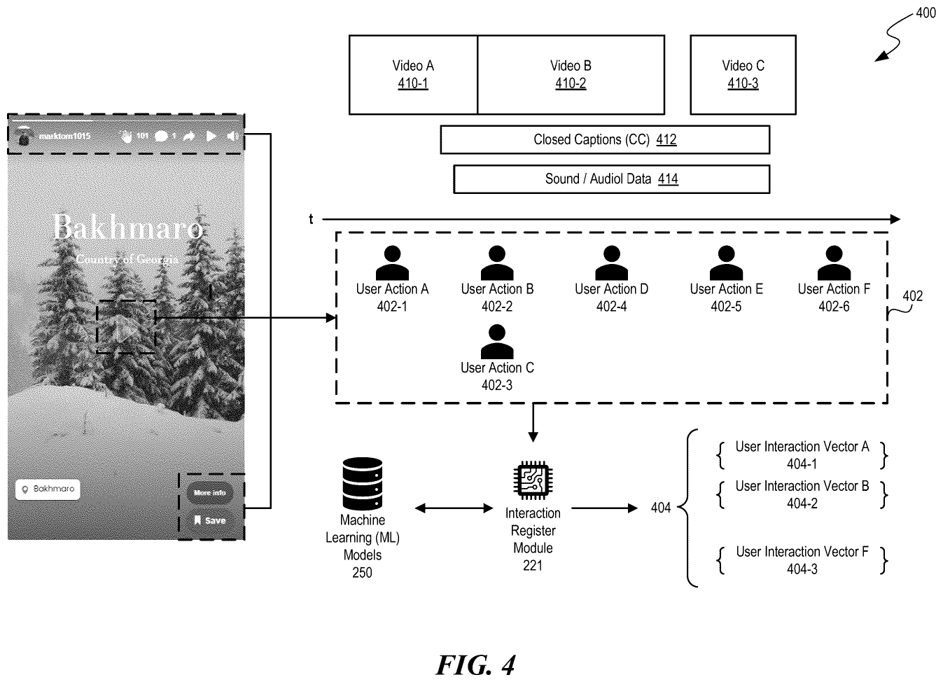

FIG. 4 is a block diagram that illustrates an example process of transforming monitored user actions in accordance with some implementations of the present technology. As shown, the interaction register module 221 can actively monitor (e.g., via real-time background listener probes and/or programs) user-initiated interactions (“user actions 402”) at a user interface when viewing digital content (e.g., an image, a video, and/or the like). For example, the interaction register module 221 can monitor and/or record user activity (e.g., starting video, pausing video, saving video, sharing video, submitting comments, and/or the like) during playback of a seed video 410 that is associated with a geographic location. In some implementations, the interaction register module 221 can detect instances of user activity (e.g., with respect to the digital content) via monitoring real-time activation, or invocation, of Graphical User Interface (GUI) elements at the user interface, changes to client-side scripts on the user interface, and/or server-side requests to retrieve or modify data stored in the computing database 204. In some implementations, the interaction register module 221 can identify a set of metadata parameters (e.g., at the user interface) that describe contextual information associated with the invocation of one or more user actions 402, such as a timestamp and/or duration of an action invocation, a frequency (e.g., local and/or global) of action invocation, a mapping of additional user activity (e.g., other detected user actions 402) related to an action invocation, and/or a combination thereof.

Using the monitored user actions 402, the interaction register module 221 can generate a corresponding set of user interaction vectors 404 that uniquely characterizes the detected user actions 402 (e.g., via the user interface) for the viewed digital content (e.g., a seed video of geographic location). A generated user interaction vector 404 for a given user action 402 represents a quantitative data structure (e.g., a list numeric variables, a standardized grouping of weights, a multi-dimensional space, and/or the like) that comprises characteristic elements (e.g., variable weights, boolean indicators, and/or the like) describing an action type (e.g., direct, indirect actions) of the recorded user action 402 and/or additional contextual metadata information (e.g., a timestamp, a duration of action, a cursor movement pattern, an associated video data, additional user data, and/or the like) at the time of recording the user action 402. In some implementations, the interaction register module 221 can use a generative machine learning model (e.g., a large language model) to create a text-based component (e.g., a human-readable narrative) of the user interactive vector 404.

In some implementations, the interaction register module 221 can detect user actions 402 before and/or after viewing of a digital content (e.g., playback of the seed video). As an illustrative example, the interaction register module 221 can detect a transition of user activity from reviewing the digital content (e.g., the seed video) to reading an integrated comment forum (e.g., an embedded chat connecting participant users) associated with the digital content. In additional or alternative implementations, the interaction register module 221 can detect user actions 402 that are not directly linked (e.g., origin and/or source media) to playback of the seed video (e.g., communicating with other users on the system, rating the seed video, clicking on related videos, and/or any combination thereof). In some implementations, the interaction register module 221 can detect both direct (e.g., user imitated actions) and/or indirect (e.g., imperceptible and/or passive actions) forms of user actions 402. For example, direct forms of user actions 402 can include starting video playback, pausing/stopping video playback, rating the video, liking/disliking the video, jumping to different sections of the video, video playback duration, replaying one or more segments of the video, commenting on the video, sharing the video to other users on the system, reposting the video, watching the video to completion, clicking on additional recommended videos/links (e.g., click-through rate), bookmarking/saving the video for future viewing, and/or any combination thereof. Further, indirect forms of user actions 402 can include duration of not interacting with the seed video playback, duration between pausing and resuming playback, amount of playback time skipped, browsing history of the user (e.g., previously viewed videos), user search queries, user interaction with content similar to the seed video (e.g., genre, topics, or creators of similar content), duration viewing video previews (e.g., thumbnails), recorded patterns of pausing and resuming the video, recorded skip patterns (e.g., portions of video ignored by the user), duration of playback session, device and system information (e.g., type of hardware and software used to display the video), and/or any combination thereof.

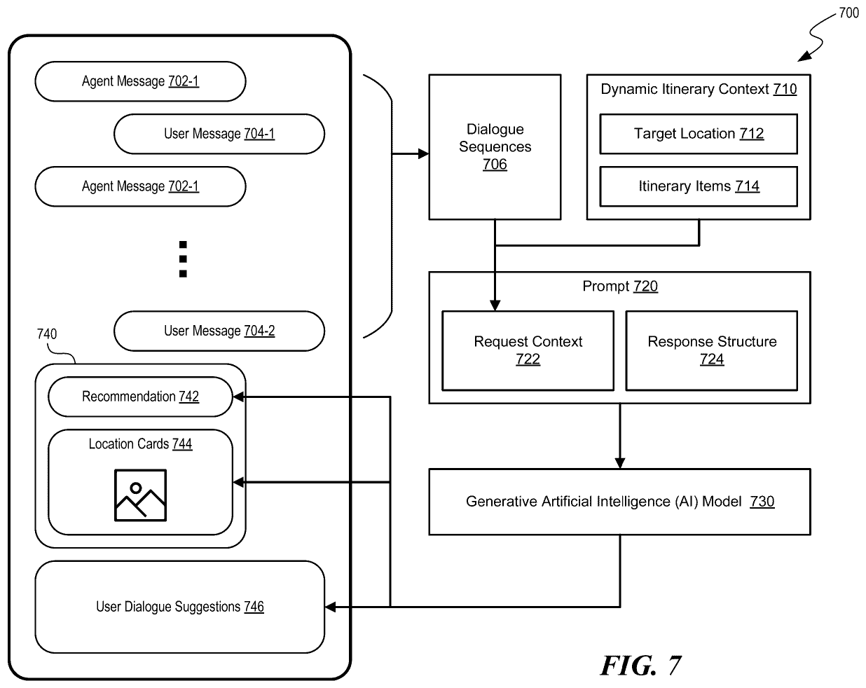

In some implementations, the interaction register module 221 can detect user activity associated with communicative interactions (e.g., a text-based message dialogue) between the user and a generative agent that is described in further detail with respect to FIG. 7. For example, the interaction register module 221 can actively monitor and/or record component dialogues (e.g., alphanumeric text messages) that are exchanged between the user and the generative agent during the communicative interaction. In another example, the interaction register module 221 can determine one or more contextual metadata parameters that represent characteristic attributes of the monitored communicative interaction, such as a dialogue length (e.g., time duration, message count, and/or the like), a user sentiment (e.g., approximation and/or labeling of emotional attributes), a user selection of predetermined dialogue options (e.g., recommended via the generative agent), additional derivative context parameters, and/or a combination thereof. In other implementations, the interaction register module 221 can monitor posterior user activities after completion of the communicative interaction with the generative agent. For example, the interaction register module 221 can identify user selection of one or more recommended travel items (e.g., or related travel items) from the generative agent to add to the sequential structure 302 of item placeholders 304. In a further example, the interaction register module 221 can use the detected posterior user activities to calculate a user alignment score (e.g., via a machine learning model) that indicates a correlative utility factor of the generative agent on user selection preferences.

In some implementations, the interaction register module 221 can assign one or more user affinity metrics to a user action 402 that indicates an approximate (e.g., a proxy) measure of user engagement (e.g., individual and/or collaborative groups of users) with digital content (e.g., a seed video) associated with detected user activity (e.g., activation and/or invocation of actionable interface elements). For example, the interaction register module 221 can determine a positive and/or negative weight(s) for a given user action 402 to gauge relative strength of user interest in a particular attribute of the digital content (e.g., a geographic location, an accessible venue, an expense range, and/or the like) and/or additional user travel preferences. For example, the interaction register module 221 organizes approximate weight values for the user action 402 as either individual scores or as a unique single vector attributed to the user action 402. The magnitude and direction of the user action 402 weights can be static across all user action 402 instances of the same user action type. In additional or alternative implementations, the magnitude and direction of the user action 402 weights can be calculated dynamically based on available metadata information. For example, the interaction register module 221 assigns a static positive weight for liking the seed video as an indication of user interest or assigns a dynamic positive weight that reflects the user interest in a particular genre of travel locations, activities or events. In another example, the interaction register module 221 can use a predetermined ruleset (e.g., a heuristic schema) that maps individual user actions 402 to a constant weight. In another example, the interaction register module 221 can apply a machine learning model (e.g., a reinforcement learning algorithm, a neural network, and/or the like) on the detected user actions 402 and/or contextual metadata to approximate the action weights. In another example, the interaction register module 221 can assign higher (e.g., or lower) weights to individual user actions 402 that demonstrate strong (e.g., or weak) correlative characteristics with other detected and/or recorded user actions 402.

In some implementations, the interaction register module 221 generates a set of user interaction vectors using the quantified user actions. Each user interaction vector 404 can be a distinguished set of different sized vectors, individual vectors of same length, and/or a two-dimensional matrix array. The user interaction vectors 404 can be stored onto the user profile database 270 of the computing database 204 and are accessible to the memory 220 modules of the computing server 202.

In other implementations, the interaction register module 221 can generate each user interaction vector 404 as a set of characteristics about the user based on user actions 402. For example, the interaction register module 221 can generate a user interaction vector 404 based on user actions with a database object corresponding to a hotel reservation. Using the user actions, the interaction register module 221 can identify key user interests (e.g., cheap reservations, room service, on-site pool, location ambience) and group them into a set of user characteristics. In additional or alternative embodiments, the interaction register module 221 can convert the set of user characteristics into compact vector arrays.

In other implementations, the interaction register module 221 can dynamically generate individual user action 402 weights based on a unique combination of detected user actions. For example, the interaction register module 221 can initialize weights of each detected user action to a default value (e.g., a float point value between 0 and 1) and incrementally adjust the initialized weights based on the unique combination of detected user actions. As an example, the interaction register module 221 detects three user actions—A, B, and C—where user action A is strongly implied by combination of user actions B and C, but user action A is weakly implied by only user action B. For a first user, the interaction register module 221 can detect all three user actions and dynamically adjust the default value for user action A to be of high magnitude. For a second user, the interaction register module 221 can detect user actions A and B but no detection of user action C and dynamically adjust the default value for user action A to be of low magnitude. In additional or alternative embodiments, the interaction register module 221 can assign probabilistic values (e.g., floating point values between 0 and 1) to each user action in lieu of generic weights. Accordingly, the interaction register module 221 can assign default probabilistic values to each user action indicating a set of prior probabilities. The interaction register module 221 can dynamically adjust the weights of the user actions by incorporating probabilistic statistical analysis (e.g., Bayesian analysis) to generate a set of posterior probabilities for the user actions. Accordingly, the interaction register module 221 can use the posterior probabilities to generate the set of user interaction vectors 404.

In some implementations, the interaction register module 221 can use statistical inference models (e.g., machine learning models, generative machine learning models, and/or the like) from the machine learning model (ML) 250 database to generate the user interaction vectors 404. For example, the interaction register module 221 uses weighted values of each user action as model inputs to generate the user interaction vectors 404. In additional or alternative implementations, the interaction register module 221 uses the machine learning model, NLP system, and/or generative machine learning system to assign weights to each user action. For example, the interaction register module 221 submits a vector of binary signals (e.g., 0 or 1) that indicates presence of a user action. Accordingly, the interaction register module 221 enables the ML model to perform internal weighing of detected user actions and generate the set of user interaction vectors 404.

In some implementations, the interaction register module 221 uses time stamps and/or duration of user actions as inputs for generating the set of user interaction vectors 404 from the machine learning models. For example, the interaction register module 221 inputs a first time stamp and a first set of weighted user actions to generate a first set of user interaction vectors 404 from the model, and input a second time stamp and a second set of user actions to generate the second set of user interaction vectors 404. In additional or alternative implementations, the interaction register module 221 combines the first and second set of user interaction vectors 404 into new composite user interaction vectors 404. In some implementations, the interaction register module 221 uses the generated set of user interaction vectors 404 as partial inputs in generating a subsequent set of interaction vectors from the model. For example, the interaction register module 221 uses the first set of user actions (e.g., user interactions with a seed video) as input to generate the first set of user interaction vectors 404 and uses the first set of user interaction vectors 404 and the second set of user actions (e.g., sharing the seed video with another user) to generate the second set of user interaction vectors 404 (e.g., augmented user interaction vectors based on the first set of user interaction vectors). In another example, the interaction register module 221 can modify (e.g., scale) portions of the generated second set of user interaction vectors 404 based on component attributes (e.g., a comparative similarity score, divergence score, and/or the like) of the first set of user interaction vectors 404. As shown, FIG. 4 illustrates examples of user actions 402 (e.g., via a user interface) before, during, and/or after video playback at various time stamps. The interaction register module 221 detects a set of user actions (User Action A . . . User Action E) at the user interface during playback of the seed video (and/or other videos in the system) and can identify specific user actions/types.

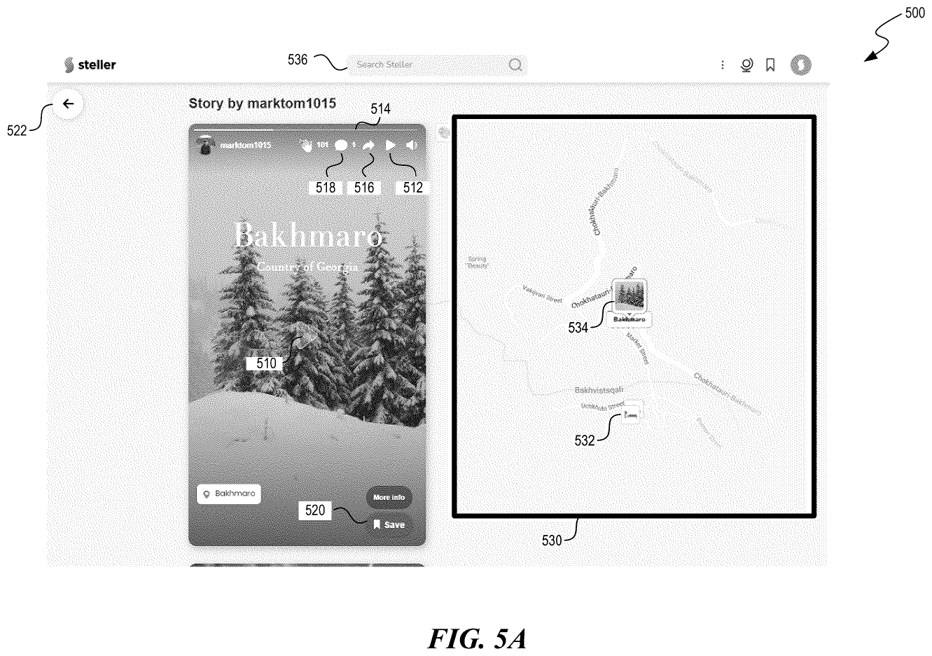

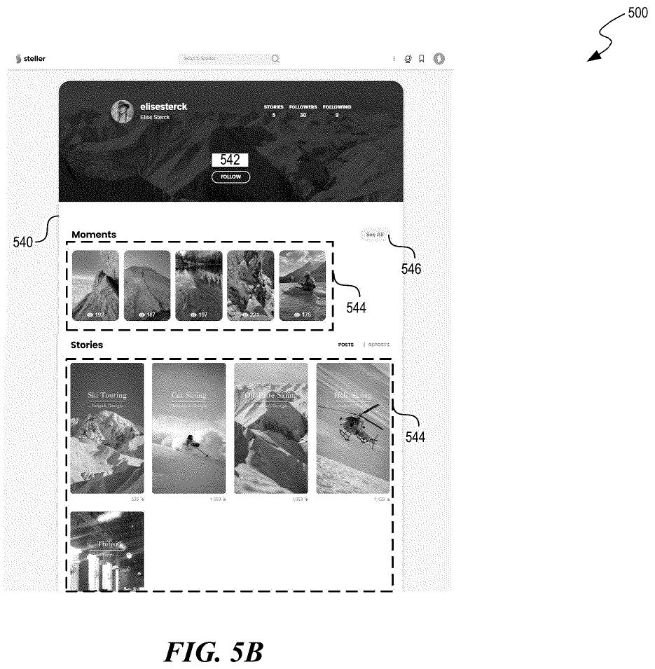

FIGS. 5A-5B is a block diagram that illustrates examples of user action detection mechanisms in accordance with some implementations of the present technology. FIG. 5A illustrates examples of user actions associated with a video via the user interface. For example, the interaction register module 221 can detect video playback 510, pausing/stopping video playback 512, skipping portions of video playback 514, sharing the video 516, commenting on the video 518, following a user related to the video, saving the video 520, engagement time with the video, searching for an item related to the video 536, clicking on specific destination related to the video, exiting video playback 522, emoticon/emoji selection, upvote, downvote, zoom in, zoom out, add/update/delete comment(s), add/update/delete annotation(s), and/or any combination thereof. In additional or alternative embodiments, the interaction register module 221 can detect both direct and indirect forms of user actions. In other embodiments, the interaction register module 221 can identify and track facial expressions, gestures, and/or movement of the user through the user interface as additional user actions. In additional or alternative embodiments, the interaction register module 221 can use the tracked facial expressions, gestures, and/or movement of the user to categorize other user actions with the system. In some implementations, the interaction register module 221 actively detects user actions on the system across multiple video playbacks and/or without video playback. For example, the interaction register module 221 detects user actions A-F, which are located at time stamps that encompass playback of multiple videos (e.g., videos A-C) and periods of no video playback.

The interaction register module 221 can also track time stamps of detected user actions. Accordingly, the interaction register module 221 can group one or more user actions based on their associated time stamps and/or interaction modalities (e.g., a video interaction, an audio interaction, a text-based interaction, and/or the like). For example, the interaction register module 221 can group user actions B and C together since both user actions occur at the same time. In another example, the interaction register module 221 can group user actions B and C together when both actions correspond to user interactions (e.g., graphical button selections) with the same modality (e.g., a video). Further, the interaction register module 221 can either group both user actions B and C as a single user action signal or separate individual signals. In some implementations, the interaction register module 221 can track if visual captions 412 and/or audio 414 is present during detection of user actions. In additional or alternative implementations, the interaction register module 221 can also record the duration of user actions and/or the frequency of user actions within a specific time duration. In other implementations, the interaction register module 221 can include metadata information of the video being interacted with (e.g., geotags or geographic identifiers, video tags, hashtags, place IDs, place descriptions, titles) alongside the weighted user actions in generating user interaction vectors 404.

In other implementations, the interaction register module 221 can track user actions that interact with content related to the seed video produced by other users. For example, the interaction register module 221 detects user comments, ratings, notifications, requests, and/or messages that are in response to user actions on the seed video (e.g., comments and/or ratings) of a second user on the system. In another example, the interaction register module 221 can track collaborative user activities with other users, such as creation of a shared itinerary structure that comprises at least one travel item associated with the seed video (e.g., geographic location). In another example, the interaction register module 221 can track mutually correlated activities (e.g., similar user interactions and/or affirmative attributes) between a user and other participant users. In additional or alternative implementations, the interaction register module 221 generates a set of interaction vectors based on the user actions in response to user actions of the second user. The preference module 222 can retrieve the set of user interaction vectors 404 corresponding to the user actions in response to user actions of the second user to generate an updated preference vector for the end user. The set of user interaction vectors 404 indicate similarity or dissimilarity of interests between the user and the second user. Accordingly, the updated preference vector can have more similar, or more dissimilar, characteristics to those of the preference vector of the second user. In additional or alternative embodiments, the system can use the updated preference vector to recommend additional seed videos that align with the update preference vector characteristics.

The interaction register module 221 can identify database objects that the user interacts with. For example, the interaction register module 221 recognizes database objects that refer to geographic locations 530, entities 532, users 534, and/or events, each with an associated set of object properties. For example, the system can record (e.g., at computing database 204) a hotel object that can have properties such as price, location, atmosphere, architecture, decor, scent, loudness, color, brightness level, temperature level, amenities, and/or any relevant ambient quantitative and qualitative attributes.

FIG. 5B illustrates examples of user actions not associated with the videos that the interaction register module 221 can detect. For example, the interaction register module 221 can detect user actions including selecting a user profile 540 on the system, following another user 542, duration spent on the user profile, looking at user shared videos 544, clicking on user shared videos 544, clicking to see more user shared videos 546, commenting on videos, communicating with users on the system outside of the seed video, and/or any combination thereof.

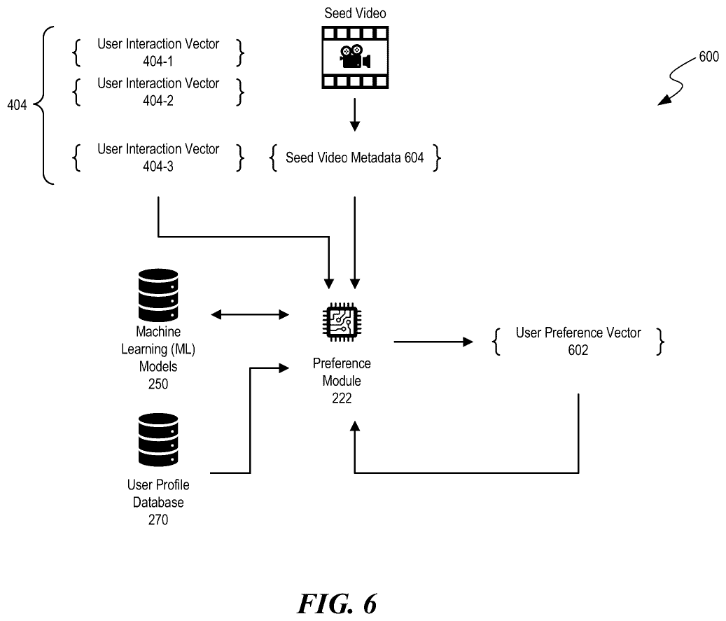

FIG. 6 is a block diagram showing some of the components typically incorporated in generating unique preference vectors in accordance with some implementations of the present technology. The user preference vector 602 represents a unique digital preference profile of the user that can be used to compare and match with other preference vectors 602 of users, database objects (e.g., travel locations, activities, venues), and/or any combination thereof. For example, the preference module 222 can generate a standardized data structure (e.g., a sparse matrix, a rule-based system, a set of tags and/or keywords, a graph-based model, a probabilistic model, a hierarchical structure, a Bayesian model, and/or the like) comprising characteristic attributes that indicate user preferences and/or priorities. The preference module 222 of FIG. 2 can store the preference vectors 602 in the computing database 204 of FIG. 2.

The preference module 222 of FIG. 2 can derive a user preference vector 602 for a participant user using one or more observed preference signals, such as the set of user interaction vectors 404 generated via the interaction register module 221, metadata information associated with the seed video 604 reviewed by the user, and/or additional user specific attributes (e.g., user demographics, profile data, predetermined priorities, and/or the like). For example, the preference module 222 can categorize the observed preference signals into discrete signal groups (e.g., direct and/or indirect user actions, social factors, contextual parameters, and/or the like) that each represent, or contribute to, one or more preference attributes (e.g., geographic environments, activity types, financial expenses, and/or the like) of the participant user. Accordingly, the preference module 222 can use the observed preference signals from each signal group to determine a portion of the user preference vector 602 (e.g., a partial vector component, a set of characteristic attributes, and/or the like). In some implementations, the preference module 222 can also assign a weighting (e.g., a scalar factor, a priority order, and/or the like) to each signal group, which indicates an approximate representation strength of the signal group in characterizing portions of the user preference vector 602. For example, the preference module 222 can assign a higher representative priority for direct user interactions compared to indirect user interactions for determining the user preference vector 602. Accordingly, the preference module 222 can initialize the user preference vector 602 (e.g., numeric weights) using preference signals (e.g., user interaction vectors) associated with direct user actions (e.g., user playback of seed video) and subsequently updating the user preference vector 602 (e.g., at a reduced numeric scalar factor) using preference signals associated with indirect user actions (e.g., measured playback duration).

In some implementations, the preference module 222 determines the preference vector 602 as a simple average rating, or composite vector data structure, of the set of user interaction vectors 404. In other implementations, the preference module 222 can dynamically update the user preference vector 602 in response to real-time detection of additional user interaction vectors 404 generated via the interaction register module 221. In some implementations, the preference module 222 can dynamically magnify components of the user preference vector 602 (e.g., scale numerical weights) in response to determining minimal variations in user interaction vectors 404 and/or user affinity metrics (e.g., consistent and/or continued user interaction patterns). In additional or alternative implementations, the preference module 222 uses interaction vectors 404 associated with other users in generating the user preference vector 602. For example, the preference module 222 can use a second user preference vector 602 of a second user to calculate the user preference vector for the user. Accordingly, when the video the user is interacting with was recommended by a second user, the second user's preference vector 602 can be used in the calculation of the first user's preference vector 602. In another exmaple, the preference module 222 can calculate an aggregate composite vector of the user interaction vectors 404 of other users connected to the user. In some implementations, the preference module 222 can assign a default preference vector 602 to the user and update the existing preference vector 602 on future calculation of the user preference vector 602.

In some implementations, the preference module 222 can iteratively update a user preference vector 602 via a performance comparison with a prior version of the user preference vector 602. For example, the preference module 222 can access (e.g., from a remote database) a first user preference vector 602 (e.g., a current version of the user preference vector 602) that corresponds to a first performance score representing approximate user satisfaction (e.g., click-through rates, quality survey results, and/or the like) of recommended geographic locations and/or travel items based on the first user preference vector 602. The preference module 222 can use observed user preference signals (e.g., monitored user interaction vectors) to update the first user preference vector 602 and generate a second user preference vector 602. Using the second user preference vector 602, the preference module 222 can determine a set of recommended geographic locations and/or travel items for the participant user. Accordingly, the preference module 222 can also monitor user activity (e.g., selection to add recommended travel items) to evaluate a second performance score that represents user satisfaction with the set of recommended geographic locations based on the second user preference vector 602. In response to the second performance score exceeding the first performance score, the preference module 222 can replace the first user preference vector 602 with the second user preference vector 602. In response to the first performance score exceeding the second performance score, the preference module 222 can revert to using the first user preference vector 602.

In some implementations, the preference module 222 can use machine learning models (e.g., a neural network, a large language model, a natural language algorithm, statistical inference systems from the machine learning (ML) models 250 database, and/or the like) to refine portions of the user preference vector 602. For example, the preference module 222 can prompt a generative machine learning model (e.g., a large language model) to identify additional keyword tags (e.g., corresponding to available travel items) that comprise high content similarities with existing keyword tags assigned to the user preference vector 602. Accordingly, the preference module 222 can add the identified additional keyword tags to the user preference vector 602.

In some implementations, the preference module 222 calculates preference vectors 602 for database objects (e.g., travel locations, items) using associated object properties, metadata information, preference vectors 602 of the user, and/or any combination thereof. For example, the preference module 222 can generate a preference vector 602 for a database object corresponding to a popular geographic location using the properties of that database object (e.g., geographic location, similar proximate locations, climate, seasons, points of interests, hotels, restaurants), metadata (e.g., user ratings, geographic distances between database objects), and/or preference vectors 602 of previous visitors (e.g., other participant users). In additional or alternative implementations, the preference module 222 can compare preference vectors 602 of different database objects types to assess similarity. For example, the preference module 222 can compare the user preference vector 602 with preference vector 602 of database objects corresponding to popular geographic locations to identify popular geographic locations that align with travel preferences of the user. In some implementations, the preference module 222 can generate a set of preference vectors 602 as a multidimensional array (e.g., matrix) that captures preference vectors 602 for multiple database objects.

FIG. 7 is a block diagram that illustrates a dialogue generation process in accordance with some implementations of the present technology. For example, the interactive signal processing system 200 can generate recommendation messages 702, 740 for a generative agent in responding to user input messages 704 (e.g., recommendation requests, follow-up dialogues) for an itinerary planning dialogue (e.g., from application 226). As shown, the recommendation module 223 can retrieve a dialogue sequence 706 of messages 702, 704 shared between the generative agent and the end user with respect to a target itinerary location (“target location”). In some implementations, the recommendation module 223 can be configured to limit the total number of messages identified in the dialogue sequence 706 up to a specified threshold count of recent messages between the generative agent and the end user. In other implementations, the recommendation module 223 can retrieve a dialogue sequence 706 of messages 702, 704 shared between the generative agent and a plurality of users (e.g., a group conversation). In some examples, the recommendation module 223 can represent the plurality of participant users of the dialogue sequence 706 as a single entity, or end user. As a result, messages 702, 704 associated with different participant users of the dialogue sequence 706 can be represented as a set of messages associated with a single user interacting with the generative agent. In other examples, the recommendation module 223 can represent the plurality of participant users as individual (e.g., independent) users.

In other implementations, the preference module 222 can identify relevant prior dialogue sequences (e.g., for dialogues outside of the target location) between the generative agent and the end user. As an illustrative example, the preference module 222 can compare a user preference vector (e.g., from the user profile database 270) with stored dialogue embedding vectors (e.g., from dialogue database 260) to identify a set of similar dialogue embedding vectors. In particular, the preference module 222 can use statistical methods (e.g., cosine similarity, Bayesian analysis) and/or machine learning models 250 to identify the similar dialogue embedding vectors. The preference module 222 can determine one or more prior dialogue sequences corresponding to at least one dialogue embedding vector from the set of similar dialogue embedding vectors. Accordingly, the preference module 222 can combine the determined one or more prior dialogue sequences and the dialogue sequence 506 for the target location into a comprehensive dialogue context data.

In some implementations, the preference module 222 can identify relevant dialogue sequences between the generative agent and a plurality of end users. For example, the preference module 222 can retrieve a first preference vector for a first user and a second preference vector for a second user from the user profile database 270. Accordingly, the preference module 222 can compare the first and the second preference vectors with stored dialogue embedding vectors to identify a set of similar dialogue embedding vectors for the entire group of users. Similarly, the preference module 222 can determine one or more relevant prior dialogue sequences for the plurality of users corresponding to at least one dialogue embedding vector from the set of similar dialogue embedding vectors.

In additional or alternative implementations, the recommendation module 223 can store the retrieved dialogue sequence 706 onto the dialogue database 260 for future dialogue context data. For example, the recommendation module 223 can embed (e.g., using a machine learning model 250) the dialogue sequence 706 into a dialogue embedding vector based on preference vectors for one or more users. Accordingly, the recommendation module 223 can store the dialogue embedding vector, the dialogue sequence 706, and a mapping between the dialogue embedding vector and the dialogue sequence 706 onto the dialogue database 260. In other implementations, the recommendation module 223 can use machine learning models 250 to evaluate an updated preference vector for a user based on the user preference vector and the dialogue embedding vector. For example, the recommendation module 223 can update the user preference vector (e.g., adjusting vector weights and/or priorities) based on values of the dialogue embedding vector to closely reflect latest preferences for the user.

The itinerary management module 224 can obtain a dynamic itinerary context 710 corresponding to the target location. For example, the itinerary management module 224 can retrieve a declarative data structure (e.g., from the itinerary database 280) comprising at least a geographic information of the target location (e.g., location identifier, address, coordinates, official name, descriptions, and/or the like), an existing set of user-selected itinerary activities (e.g., tourist locations, venues, local events, and/or the like), additional user preference information, or a combination thereof. Each itinerary activity within the set of user-selected itinerary activities can comprise geographic information for the activity, one or more planned (e.g., reserved) events, an approximate financial cost, or a combination thereof.

The recommendation module 223 can combine the dialogue sequence 706 (e.g., and prior dialogue sequences) and the dynamic itinerary context 710 into a single request context 722 data. Accordingly, the recommendation module 223 can use the request context 722 data to prompt a generative machine learning model 730 for generating itinerary recommendations and dialogue suggestions for the end user. For example, the recommendation module 223 can request a generative machine learning model 730 to generate a list of recommended itinerary activities nearby the target location based on the request context 722 data. Furthermore, the recommendation module 223 can request the generative machine learning model 730 to generate a list of suggested follow-up dialogues for aiding the end user in asking more specific inquiries into the target location, a specific itinerary activity, or generated responses from the generative agent. In some implementations, the recommendation module 223 can request the generative machine learning model 730 to generate a text-based narrative summarizing the list of recommended itinerary activities.

In additional or alternative implementations, the recommendation module 223 can include a desired response structure 724 within submitted prompts to refine and/or adjust output response formats from the generative machine learning model 730. For example, the response structure 724 can specify a particular machine-readable format (e.g., JSON, YAML, and/or the like), a set of required content items (e.g., topics discussed in generated response), a response style (e.g., tone of voice, mannerisms, writing structures, and/or the like), or a combination thereof. In some implementations, the recommendation module 223 can prompt a generative machine learning model stored on the computing database 204 (e.g., machine learning models 250). Alternatively, the recommendation module 223 can submit prompting requests to third-party generative machine learning models (e.g., ChatGPT®) via application programming interfaces (“API”).

In other implementations, the recommendation module 223 can be configured to process recommendation results (e.g., recommended itinerary activities and/or suggested dialogues) for a dialogue sequence 706 without prompting a generative machine learning model 730. For example, the recommendation module 223 can be configured to store a prompting record (e.g., on cache memory and/or computing database 204) comprising a request context 722 (e.g., dialogue sequence 706, itinerary context 710, user preference vectors, prompt 720, and/or the like), a response structure 724, and/or recommendation results based on the request context 722 and the response structure 724. Accordingly, the recommendation module 223 can search stored prompting records to find a prior prompting record that shares similarities with the current prompt 720, request context 722, and/or response structure 724. In response to identifying a valid prior prompting record, the recommendation module 223 can skip prompting of the generative machine learning model 730 and directly return the recommendation results stored in the prior prompting record.

In some implementations, the recommendation module 223 can be configured to validate recommendation results (e.g., authenticity and/or existence of recommended activities) retrieved from the generative machine learning model 730. For example, the recommendation module 223 can be configured to verify geographic metadata (e.g., location name, address, identification number, geographic coordinates, viewport radius, and/or the like) corresponding to the recommended itinerary activities to ensure the recommended activities are legitimate. In another example, the recommendation module 223 can access (e.g., via a remote stored database, a web-based API, and/or the like) at least one verified review from a prior participant user of the recommended itinerary activities to validate the recommended activities. In another example, the recommendation module 223 can transmit (e.g., via an API) a validation request to an online service provider associated with a recommended itinerary activity to verify the existence and/or accessibility of the recommended activity. In some implementations, the recommendation module 223 can accept manual validation of recommended itinerary activities from external authorized users (e.g., privileged users, maintenance personnel, service providers, and/or the like). In some implementations, the recommendation module 223 can compare the recommended itinerary activities with validated location entries stored on the itinerary database 280 to determine legitimacy. In other implementations, the recommendation module 223 can submit a verification request to a third-party application and/or service (e.g., Google Maps®) via an API to determine legitimacy. In response to determine an illegitimate recommendation, the recommendation module 223 can selectively remove the invalid activity from the list of recommended itinerary activities.

The dialogue generation module 225 can use the responses from the generative machine learning model 730 to create user-interactable dialogue responses for the generative agent. For example, the dialogue generation module 225 can create a text message 740 response based on recommendation results (e.g., list of recommended itinerary activities, narrative recommendation 742, and/or the like) that is appended onto the dialogue sequence 706. In some implementations, the dialogue generation module 225 can embed user-interactable itinerary cards 744 within the message 740 response. In additional or alternative implementations, the dialogue generation module 225 can create selectable user dialogue suggestions 746 for display near the primary dialogue sequence 706. In response to selection of at least one user dialog suggestion, the interactive signal processing system 200 will automatically populate the user input field and submit the at least one user dialog suggestion as new user input messages 704. In other implementations, the system will populate the user input field and enable the user (e.g., or a plurality of users) to further edit the message contents prior to submission.

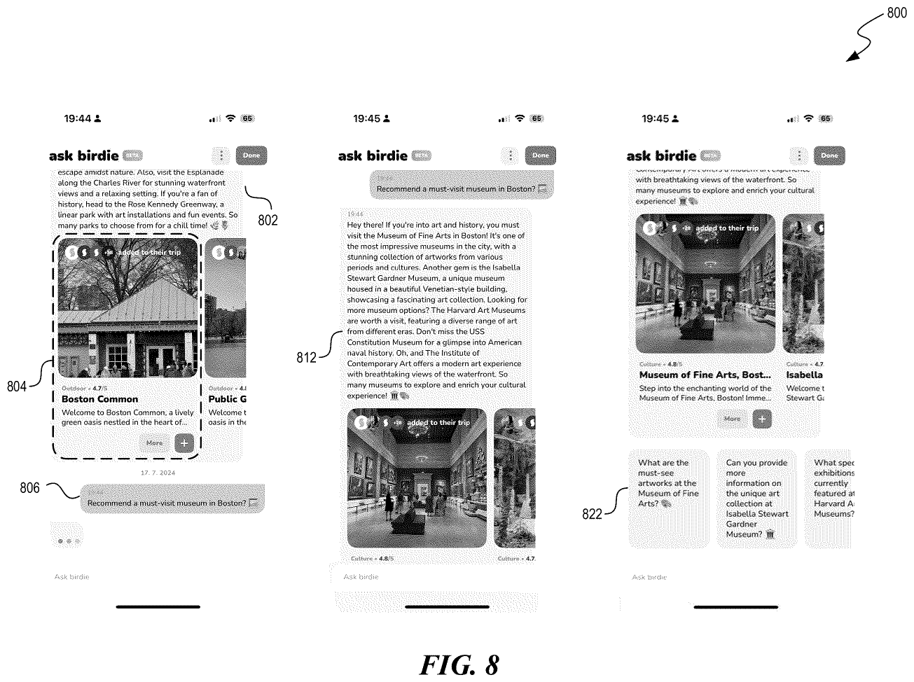

FIG. 8 is a block diagram that illustrates examples of user-interactable interface elements in accordance with some implementations of the present technology. As shown, FIG. 8 illustrates examples of available user actions and user-interactable elements (e.g., itinerary cards, suggested follow-up dialogue) on a user interface (e.g., of a user device) when engaging in a dialogue 800 (e.g., via application 226) with a generative agent of the interactive signal processing system 200. For example, the generative agent can initiate dialogue 800 with a message 802 recommending one or more itinerary activities (e.g., locations, events, and/or the like) that are local to a target location selected by an end user (e.g., or a plurality of users). The message 802 can comprise a text-based recommendation that describes the one or more itinerary activities and/or additional relevant details for the target location. The initial message 802 can also comprise one or more itinerary cards corresponding to the one or more recommended itinerary activities.

As shown, an itinerary card 804 for an activity can include a location photograph, a title of the activity, a short-hand description of the activity, and/or shortcut options (e.g., buttons available on card) that adds the activity to a dynamic itinerary for the target location. In additional, or alternative implementations, the itinerary card 804 can redirect users to an activity specific page on the itinerary generation system in response to a user selection of the card 804. The activity specific page comprises further detailed information corresponding to the activity, the location of the activity, a cost of participation, a set of available timeslots, a set of prior user reviews, and/or any combination thereof. In other implementations, the itinerary card 804 can be linked to an external resource (e.g., an official webpage corresponding to the activity, a third-party navigation item, and/or the like).

In further implementations, the end user (e.g., or plurality of end users) can submit an input message 806 (e.g., a description, a dialogue, and/or the like) to the dialogue 800 in response to the latest recommendation messages from the generative agent. In some implementations, the user (e.g., or plurality of users) can select a suggested dialogue (e.g., follow-up dialogue) from a set of suggested dialogue 822 as the input message 806 to initiate a follow-up dialogue to messages (e.g., itinerary card 804) from the generative agent. Accordingly, the generative agent is prompted to respond to new user input messages 806 added to the dialogue 800 with new recommendation messages 816, new suggested dialogues 822 for user-initiated follow-up dialogue, or a combination of both. As shown, suggested dialogues 822 for the user (e.g., or plurality of users) can be presented separately (e.g., at bottom of dialogue scroll) from the primary dialogue 800 between the end user (e.g., or plurality of users) and the generative agent, thus enabling the end user (e.g., or plurality of users) to seamlessly review relevant messages (e.g., itinerary card 804) from the generative agent and suggested dialogues 822 for follow up dialogue. In additional or alternative implementations, the end user can submit a multi-modal message (e.g., a combination of text, image, and/or audio data) to the dialogue 800.

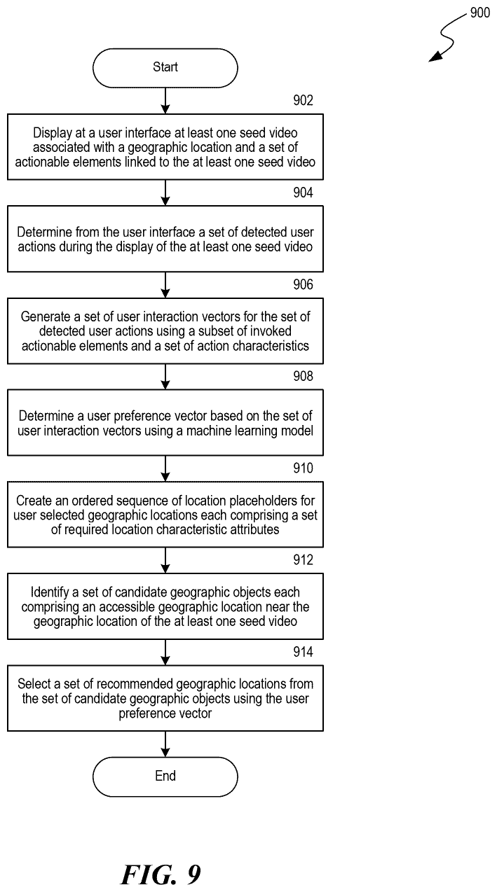

FIG. 9 is a flowchart that illustrates a process 900 for determining custom geographic location recommendations in accordance with some implementations of the present technology. The process 900 can be performed by a system (e.g., an interactive signal processing system 200) configured to analyze user preferences and/or engagement metrics (e.g., via comparison of interaction and/or preference vectors) to identify one or more recommended geographic locations for building a personalized travel itinerary. In one example, the system includes at least one hardware processor and at least one non-transitory memory storing instructions, which, when executed by the at least one hardware processor, cause the system to perform the process 900. In another example, the system includes a non-transitory, computer-readable storage medium comprising instructions recorded thereon, which, when executed by at least one data processor, cause the system to perform the process 900.

At 902, the system can display (e.g., at a user interface) at least one seed video associated with a geographic location and a set of actionable elements (e.g., user interactable widgets) linked to the at least one seed video. In some implementations, the system can access location metadata information (e.g., location name, geotags, location tags, geographical coordinates) from the seed video. For example, the system can extract geotags and other identifiable location information based on labels, texts, links, user-generated content interactions, closed captions, hashtags, and/or place identification numbers associated with the seed video. In some implementations, the seed video can be either a playable video stream or a set of images uploaded by the end user or other users using the system.

In some implementations, the system can use machine learning models from the machine learning (ML) database 250 to generate location metadata information based on available metadata associated with the seed video. For example, the system can generate a location tag from a model output using text description associated with the seed video. In other implementations, the system can use machine learning models to generate location metadata using the seed video, or images. For example, the system can generate geotags or approximate geographical coordinates from a computer vision (CV) model output using the images from the seed video.

In some implementations, the system can identify the geographic location (e.g., geographic coordinates, geographic area) associated with the seed video based on the retrieved location metadata information. For example, the system can use identifiable location information (e.g., geotags) to select a geographic location from a set of known locations. In some implementations, the system can select the geographic location from the set of known locations based on a similarity metric representing likelihood of the selected location being the location featured in the seed video. Example methods of calculating the similarity metric can include Euclidean distance and cosine similarity. In additional or alternative implementations, the system can use machine learning models from the machine learning (ML) database 250 to identify an approximate geographic location based on the identifiable location information. For example, the system can generate approximate geographic coordinates from a computer vision (CV) model output using the images from the seed video.

At 904, the system can determine (e.g., from the user interface) a set of detected user actions (e.g., for an individual or group of users) during the display of the at least one seed video. For example, the system can determine detected user actions that each comprise a subset of invoked actionable elements (e.g., a user initiated selection, event, and/or interaction) linked to the at least one seed video and/or a set of action characteristics that represent contextual parameters associated with the subset of invoked actionable elements. In some implementations, the set of detected user actions during the display of the at least one seed video can comprise a start of video playback, a pause of video playback, a completed view of a specified video segment, a review of a specified video playback, an alteration of video playback speed, a rating of seed video, a submission of a publicly accessible message, a sharing of seed video, and/or any combination thereof. In some implementations, the set of action characteristics that represent contextual parameters associated with the subset of invoked actionable elements can comprise a timestamp of action invocation, a duration of action invocation, a frequency of action invocation, a user activity related to action invocation, and/or any combination thereof.

In some implementations, the system can determine a set of user interaction vectors based on user actions with the user interface in the presentation of the seed video. For example, the system can present the seed video on the user interface and use the interaction register module 221 to detect user actions on the user interface during playback of the seed video. Using the detected user actions, the integration register module 221 can calculate a set of user interaction vectors that describe the strength of each user action being indicative of user travel preferences.

In some implementations, the interaction register module 221 can detect user action before and/or after playback of the seed video (e.g., video is paused, stopped, and/or not played). The interaction register module 221 can detect user action that modifies the playback of the seed video including, but not limited to, starting playback, pausing/stopping playback, skipping sections of playback, reversing playback, altering playback speed, adjusting volume of playback, toggling closed captions, and/or any combination thereof. The interaction register module 221 can also measure user inactivity with respect to the seed video as user action. For example, the interaction register module 221 can record the duration between the user first pausing the video playback and resuming video playback as a time-based user action.

At 906, the system can use the subset of invoked actionable elements and the set of action characteristics to generate a set of user interaction vectors for the set of detected user actions. For example, the system can generate user interaction vectors that each corresponds to at least one detected user action and/or comprises one or more affinity metrics (e.g., biased weights for characteristic attributes of the geographic location) indicating strength of user engagement with the at least one seed video of the geographic location. In some implementations, the interaction register module 221 can assign weights (e.g., positive and/or negative values) to each detected user action in response to the seed video, representing the strength of a user action indicating user travel preferences. For example, a user action of positively rating the seed video can be assigned a high positive weight (e.g., +10.0) if rating a video is uncommon and a positive rating can indicate strong user engagement with the seed video. In another example, a user action of briefly pausing the seed video can be assigned a low negative weight (e.g., −0.1) since the duration between pausing playback and resuming playback was brief but could also indicate disengagement with the seed video. In other implementations, the system can use machine learning models, NLP systems, and/or generative machine learning systems from the machine learning (ML) 250 database to generate the weights for each user action.

In some implementations, the interaction register module 221 can calculate a set of user interaction vectors based on the weighted user actions. For example, the interaction register module 221 can generate a user interaction vector of specified length comprising of individual positive or negative signals based on the weighted user action. In some implementations, the user interaction vector can be a “one-hot” vector such that only a single element of the user interaction vector has a non-zero weight, and the length of the vector reflects the number of observed user actions. In other implementations, the interaction register module 221 can determine the set of user interaction vectors using machine learning models, NLP systems, and/or generative machine learning systems from the machine learning (ML) 250 database.

At 908, the system can determine (e.g., using a machine learning model) a user preference vector based on the set of user interaction vectors. For example, the system can determine, or approximate, a representative user preference vector that comprises dynamic user preference weights and/or biases for one or more characteristic attributes of geographic locations. In some implementations, the system can generate a user preference vector for the user using the set of interaction vectors. For example, the preference module 222 of the system can retrieve metadata information of seed video and user interaction vectors to calculate a composite vector representing unique travel preferences of the end user. In some implementations, the preference module 222 can assign a default preference vector the user before updating the user preference vector in a future process.

In some implementations, the preference module 222 can retrieve metadata information associated with the seed video to be used in calculating the user preference vector. For example, the preference module 222 can retrieve video tags, geotags, hashtags, place IDs, text descriptions, titles, and other descriptive information related to the seed video. In some implementations, the preference module 222 can also retrieve metadata information regarding the user that is not sourced from the seed video. For example, the preference module 222 can identify key user profile information including user connections (e.g., other users the user follows, other users that follow the user), user communication and engagement with other videos, previous trips (e.g., travel locations), and other users with similar preference vectors.

In some implementations, the preference module 222 can use the retrieved metadata information and computed user interaction vectors to generate a user preference vector for the user. For example, the preference module 222 can calculate a simple average composite vector across the user interaction vectors for the seed video and assign the composite vector as the user preference vector. In other implementations, the preference module can adjust the weight or contribution of each user interaction vector based on the retrieved metadata information. For example, the preference module 222 can scale down the weight of a positive user interaction vector associated with the user positively rating the seed video based on metadata information (e.g., of the seed video and the user) indicating that the user often avoids a price point that the seed video location is most similar to. In other implementations, the preference module 222 can use machine learning models, NLP systems, and/or generative machine learning systems from the machine learning (ML) 250 database to generate the user preference vector.

At 910, the system can create an ordered sequence of location placeholders for user selected geographic locations. For example, the system can generate an order sequence of location placeholders such that each location placeholder is configured to comprise a set of required characteristic attributes of geographic locations. In some implementations, the set of required characteristic attributes of geographic locations can comprise an environment type, an accessible venue, an accessible event, a point of interest, an available transportation mode, a time interval, a calendar date, an expense range, a quality rating, an applicable filter category, a viewable image of geographic location, a contact information, an external redirection link, or any combination thereof.

In some implementations, the system can create an itinerary of travel items (e.g., locations, venues, events) using preference vectors (e.g., user preference vectors, item preference vectors) generated by the preference module 222. For example, the itinerary management module 224 can query the recommendation module 223 to identify travel locations with preference vectors similar to the preference vector of the end user (comparable locations). Accordingly, the itinerary management module 224 can generate an itinerary of locations based on user selection from recommended travel locations.

In some implementations, the system uses the geographic location of the seed video to extract attributes of the location by querying a machine learning tool, such as a GenerativeAI tool. For example, the system queries a GenerativeAI tool, such as ChatGPT®, to extract attributes of a particular location (e.g., Seattle). The system can then issue a second query to the machine learning tool (such as, ChatGPT®) to identify other locations that correspond to the extracted attributes of the particular location. In some implementations, the system can also include the preference vectors, along with the extracted location attributes, in its query to the machine learning tool to retrieve comparable locations that are customized to the specific user. At 942, the itinerary management module 224 can generate a structure of itinerary item placeholders based on a set of travel item categories. For example, the itinerary management module 224 can generate a simple itinerary comprising a tourist location, a dining location, and a stay location. In future processes, the itinerary management module 224 can replace the itinerary item placeholders with real travel items (e.g., locations, venues, events) that are selected by the user. In some implementations, the structure of itinerary item placeholders can also be categorized or restricted by time duration and/or specific time stamps. In other implementations, the travel item categories include, but are not limited to, restaurants, stays, tourist locations, activities, points of interest, days of the week, transportation options, and/or any combination thereof.

At 912, the system can identify (e.g., from a remote database) a set of candidate geographic objects. For example, the system can determine candidate geographic objects that each comprises an accessible geographic location near the geographic location of the at least one seed video and/or a set of characteristic attributes of the accessible geographic location. In some implementations, the system can access (e.g., from a remote database) a mapping of geographic identifiers and available geographic objects, such that each geographic identifier encodes information for a specified geographic location. In further implementations, the system can identify a source geographic identifier that comprises a nearest encoded geographic location for the geographic location of the at least one seed video. The system can further determine a set of proximate geographic identifiers that comprise an encoded geographic location within a specified distance from the nearest encoded geographic location of the source geographic identifier. Accordingly, the system can select (e.g., via the mapping) a set of geographic objects that maps to the set of proximate geographic identifiers.

In some implementations, the itinerary management module 224 can use the recommendation module 223 to identify travel items (e.g., locations, activities) near the geographic location of the seed video. For example, the recommendation module 223 can retrieve the location metadata information of the seed video (e.g. geotag) to determine geographic location of the seed video and retrieve a set of known travel items (e.g., geographic locations) within the area of the seed location. In some implementations, the recommendation module 223 can retrieve known travel items that fall within a specified distance threshold from the center of the seed location. In other implementations, the itinerary management module 224 can filter the set of travel items retrieved by the recommendation module 223 based on whether each travel item can fulfill the categorical requirement of one or more itinerary item placeholders. In additional or alternative implementations, the recommendation module 223 can use metadata information not sourced from the seed video (e.g., nearby locations visited by other users, popularity of nearby locations) to filter the retrieved set of travel items. For example, the recommendation module 223 can limit the number of recommended travel items to a specified constant and identify only the most popular locations near the seed location. In an additional or alternative embodiment, the recommendation module 223 can also order the set of travel items based on metadata information. For example, the recommendation module 223 can provide a list of recommended travel items from most to least popular when presenting to the end user.

At 914, the system can select (e.g., using the user preference vector) a set of recommended geographic locations from the set of candidate geographic objects. For example, the system can identify a set of recommended geographic locations that each corresponds to a location placeholder in the ordered sequence of location placeholders and/or satisfies the set of required characteristic attributes of the corresponding location placeholder. In some implementations, the system can determine (e.g., from the user interface) a set of indirect user actions (e.g., without interactive action from user) during the display of the at least one seed video. For example, the system can determine indirect user actions that each comprise a subset of actionable elements linked to the at least one seed video that are not invoked at the user interface and/or a second set of action characteristics that represent contextual parameters associated with the subset of non-invoked actionable elements. Using the subset of non-invoked actionable elements and the second set of action characteristics, the system can generate a second set of user interaction vectors for the set of indirect user actions. In further implementations, the system can determine (e.g., using the machine learning model) a second user preference vector based on the first and the second set of user interaction vectors. Accordingly, the system can select a second set of recommended geographic locations from the set of candidate geographic objects using the second user preference vector.

In some implementations, the system can display (e.g., at the user interface) an interactive geographic object comprising at least one recommended geographic location that corresponds to a select location placeholder from the ordered sequence of location placeholders. The system can further determine (e.g., from the user interface) a second set of detected user actions during the display of the interactive geographic object. For example, the system can obtain detected user actions that each comprises a second set of invoked actionable elements linked to the displayed interactive geographic object. In some aspects, the second set of invoked actionable elements can comprise an option for assigning the at least one recommended geographic location to the select location placeholder. In response to a user selection of the option for assigning the at least one recommended geographic location to the select location placeholder, the system can generate a second set of user interaction vectors for the second set of detected user actions using the second set of invoked actionable elements such that each user interaction vector comprises one or more affinity metrics indicating strength of user engagement with the interactive geographic object. In other implementations, the system can determine (e.g., using the machine learning model) a second user preference vector based on the first and the second set of user interaction vectors. In additional or alternative implementations, the system can select (e.g., using the second user preference vector) a second set of recommended geographic locations from the set of candidate geographic objects.

In some implementations, the system can dynamically add additional geographic objects in response to at least one location placeholder from the order of location placeholders not associated to a recommended geographic location from the set of recommended geographic locations. For example, the system can access at least one set of geographic locations selected by another user. Accordingly, the system can add one or more geographic objects corresponding to geographic locations from the at least one set of geographic locations created by another user to the set of candidate geographic objects.

In some implementations, the system can access (e.g., from a remote database) a second user preference vector for a second user that is associated with the first user, the at least one seed video, or both. The system can further determine (e.g., using a machine learning model) a third user preference vector for the first user based on the first and the second user preference vectors. Accordingly, the system can use the third user preference vector to select a second set of recommended geographic locations from the set of candidate geographic objects.

In some implementations, the system can generate (e.g., using a machine learning model) a geographic reference vector based on the set of characteristic attributes of the accessible geographic location for at least one candidate geographic object. By comparing the geographic reference vector and the user preference vector, the system can further calculate a similarity score that represents user compatibility with the accessible geographic location for the at least one candidate object. In response to the similarity score exceeding a pre-defined similarity threshold, the system can dynamically add the accessible geographic location of the at least one candidate geographic object to the set of recommended geographic locations.

In some implementations, the itinerary management module 224 can replace travel item placeholders in the itinerary structure based on user selection from the set of recommended travel items. For example, the itinerary management module 224 can present the set of recommended travel items to the user via the user interface and detect user selection of a travel item and an itinerary item placeholder. Accordingly, the itinerary management module 224 can replace the itinerary item placeholder with the user selected travel item. In some implementations, the itinerary management module 224 can continue substituting the itinerary item placeholders with recommended travel items until all itinerary item placeholders are exhausted. Accordingly, the system will return to block 940 to begin another iteration. In other implementations, the itinerary management module 224 can stop substituting the itinerary item placeholders with remaining itinerary item placeholders in the itinerary structure.

In other implementations, the itinerary management module 224 can use the interaction register module 221 to detect user actions in response to presenting the recommended travel items via the user interface. For example, the interaction register module 221 can detect user selection of a recommended travel item and generate a user interaction vector associated with the selection. Accordingly, the itinerary management module 224 can use the preference module 222 to use the generated user interaction vector from the itinerary management module 224 and metadata information from the recommended travel item to calculate a new preference vector for the user. In additional or alternative implementations, the itinerary management module 224 can use the new preference vector to update the existing user preference vector.

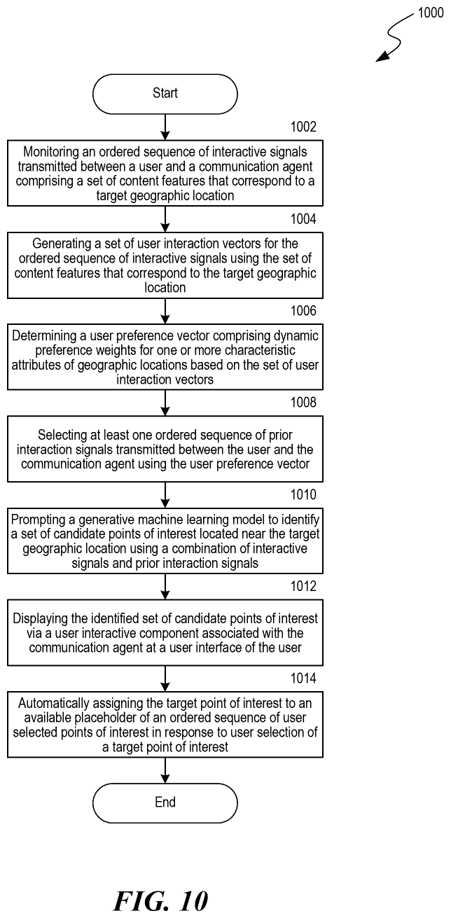

FIG. 10 is a flowchart that illustrates a process 1000 for determining custom points of interest in accordance with some implementations of the present technology. The process 1000 can be performed by a system (e.g., an interactive signal processing system 200) configured to analyze user preferences (e.g., weighted biases for geographic locations) based on contextual dialogue sequences (e.g., prior interactive exchanges with conversational agent pertaining to geographic locations, events, climate, and/or the like) to present one or more recommended point of interest (e.g., an itinerary recommendation) via interactive dialogue components. In one example, the system includes at least one hardware processor and at least one non-transitory memory storing instructions, which, when executed by the at least one hardware processor, cause the system to perform the process 1000. In another example, the system includes a non-transitory, computer-readable storage medium comprising instructions recorded thereon, which, when executed by at least one data processor, cause the system to perform the process 1000.

At 1002, the system can monitor (e.g., via a real-time application programming interface (API)) an ordered sequence of interactive signals (e.g., a turn-based sequence of conversational dialogue texts) transmitted between a user and a communication agent (e.g., a real-time virtual conversation entity and/or software program), each interactive signal comprising a set of content features that correspond to a target geographic location. In some implementations, the set of interactive signals between the user and the communication agent can comprise transmission of a human-readable alphanumeric string (e.g., a text-based message), an image, an audio signal, a video, a route (e.g., a hyperlink) to an external resource (e.g., a separate webpage, an application portal, and/or the like), a scrolling action, a submission of a message, a response to a specified message, an addition of supplementary documents (e.g., an option for adding additional attachment data), a selection of a point of interest (e.g., an addition to an existing set of user selected points of interest), a prioritization of a point of interest (e.g., assigning a favorite designation, adding to a list of point of interest for future review, and/or the like), and/or a combination thereof.

In some implementations, the set of content features that correspond to the target geographic location can comprise a location description, an environment description (e.g., a climate and/or weather information), an event description (e.g., information regarding a venue, a time duration, a transportation mode, and/or the like), an information request (e.g., user submitted questions for clarification and/or exploratory search), an additional resource corresponding to the geographic location, an image associated with the geographic location (e.g., a digital snapshot), an audio associated with the geographic location, and/or a combination thereof.

At 1004, the system can use the set of content features that correspond to the target geographic location to generate a set of user interaction vectors for the ordered sequence of interactive signals. In some implementations, the system can generate individual user interaction vectors that each comprise one or more affinity metrics (e.g., dynamic categorical weights for characteristic attributes of geographic locations, points of interest, and/or the like)) indicating strength of user engagement with the communication agent. In some implementations, the system can generate (e.g., via a machine learning model) a comparable embedding vector representative of content features of the interaction signals in response to receiving a termination condition (e.g., a user initiated close of conversational dialogue) for the ordered sequence of interactive signals transmitted between the user and the communication agent,

At 1006, the system can determine a user preference vector based on the set of user interaction vectors that comprises dynamic preference weights for one or more characteristic attributes of geographic locations. In some implementations, the system can use a machine learning model (e.g., a statistical inference model, a neural network, a large language model, and/or the like) to generate the user preference vector.

In some implementations, the system can obtain contextual dialogue sequences between a user and a generative agent on the interactive signal processing system. For example, the system can retrieve a dialogue sequence between the user and the generative agent with respect to a target location. In some implementations, the system can configure the generative agent to initiate the dialogue sequence with an introduction message based on the target location (e.g., location identifier, geographic details). In other implementations, the system can obtain a stored user preference profile (e.g., a user preference vector) for generating the introduction message for initiating the dialogue sequence. In further implementations, the system can determine additional relevant dialogue sequences (e.g., sequences recorded prior to the current dialogue) based on the stored user profile and/or preference vector. Accordingly, the system can generate a combined contextual dialogue sequence based on the current dialogue sequence and additional relevant dialogue sequences.

At 1008, the system can select (e.g., from a stored user profile) at least one recorded ordered sequence of prior interaction signals (e.g., recorded previous conversational dialogues) transmitted between the user and the communication agent using the user preference vector. In some implementations, each prior interaction signal of the recorded ordered sequence can comprise content features that correspond to a prior geographic location (e.g., primary context of dialogue of previous conversation).

In some implementations, the system can access (e.g., from a stored user profile) a set of recorded ordered sequences of prior interaction signals transmitted between the user and the communication agent, such that each recorded ordered sequence of prior interaction signals comprises a comparable embedding vector (e.g., comparable with user preference vectors) representative of content features for the prior interaction signals. In response to comparison of the embedding vector of a recorded ordered sequence of prior interaction signals and the user preference vector exceeding a similarity threshold, the system can dynamically add the recorded ordered sequence of prior interaction signals to the at least one ordered sequence of prior interaction signals.

At 1010, the system can use a combination of the ordered sequence of interactive signals and at least one ordered sequence of prior interaction signals (e.g., a composite sequence of interactive signals between a user and a communication agent) to prompt a generative machine learning model (e.g., a large language model) to identify a set of candidate points of interest located near the target geographic location. In some implementations, the system can identify (e.g., from the stored user profile of the user) a second user associated with a second user preference vector. Accordingly, the system can select (e.g., from a stored user profile of the second user) at least one ordered sequence of prior interaction signals transmitted between the second user and the communication agent using the second user preference vector. Using a combination (e.g., a composite sequence) of the ordered sequence of interactive signals and the at least one ordered sequence of prior interaction signals transmitted between the second user and the communication agent, the system can prompt the generative machine learning model to identify a second set of candidate points of interest (e.g., separate or intersecting with the first set of candidate points of interest) located near the target geographic location.

In some implementations, the system can retrieve a declarative data structure (e.g., a text-formatted data object, a data serialization language, and/or the like) that comprises dynamic contextual information associated with a user itinerary, or user selected set of points of interest. For example, the system can retrieve a declarative data structure that comprises at least one contextual information, or characteristic attribute, associated with the target geographic location and/or a set of points of interest previously selected by the user. Using a combination of the ordered sequence of interactive signals and contents of the declarative data structure, the system can prompt a generative machine learning model to identify a second set of candidate points of interest located near the target geographic location.

In some implementations, the system can use the combined sequences of interactive signals and the user preference vector to generate a search configuration record (e.g., a memory persistent data record) that corresponds to the set of candidate points of interest. The system can further access (e.g., from a remote database) a cache mapping of prior search configuration records to sets of prior candidate points of interest, such that each prior search configuration record corresponds to a set of prior candidate points of interest. In response to at least one prior search configuration record from the cache mapping comprising similar content (e.g., sequence of interactive signals, attributes of associated geographic locations, user preference parameters, and/or the like) to the search configuration record, the system can dynamically add the set of prior candidate points of interest of the at least one similar prior search configuration record to the set of candidate points of interest.

In some implementations, the system can prompt a generative machine learning model (e.g., a large language model) for creating an itinerary recommendation response (e.g., a set of recommended point of interest locations). For example, the system can retrieve a dynamic itinerary context for the target location, such as a declarative data structure comprising geographic information for the target location, an assigned name, a set of user-selected itinerary activities, or a combination thereof. In other implementations, the system can submit a request to the model for generating one or more recommended itinerary items (e.g., locations, events, activities, and/or the like) for the user. In additional or alternative implementations, the system can also submit a request to the model for generating one or more complementary user dialogue suggestions (e.g., recommended user response options) for presenting with the recommended itinerary items for the user.

At 1012, the system can display (e.g., at a user interface of the user) the identified set of candidate points of interest via a user interactive component (e.g., a text messaging service) associated with the communication agent. In some implementations, the system can generate user-interactable dialogue elements (e.g., selectable content widgets, digital descriptive item cards, and/or the like) for display at a user interface. For example, the system can use the one or more recommended itinerary items to create interactable itinerary item cards that, when selected, redirects a user to a corresponding itinerary item description on the system. For each itinerary item card, the system can include a title, a location image, a short description, an option for adding the itinerary item onto an itinerary, or a combination thereof. In some implementations, the system can use the one or more user dialogue suggestions to create user-selectable dialogue elements (e.g., user interface buttons) that, when selected, automatically appends the content (e.g., responses, questions) associated with the dialogue suggestion onto the dialogue sequence.

At 1014, the system can respond to a user selection of a target point of interest (e.g., via selection of a location item card) from the displayed set of candidate points of interest via automatically assigning the target point of interest to an available placeholder (e.g., an unassigned, or empty, portion of a travel itinerary) of an ordered sequence of user selected points of interest. In some implementations, the system can use the set of candidate points of interest to prompt a generative machine learning model to create a set of interactive user actions (e.g., message response options for continuing conversational dialogue) for extending the ordered sequence of interactive signals between the user and the communication agent. Accordingly, the system can display (e.g., at the user interface of the user) the set of interactive user actions alongside the identified set of candidate points of interest. In response to user invocation of at least one interactive user action from the displayed set of interactive user actions, the system can automatically assign the at least one interactive user action to the ordered sequence of interactive signals between the user and the communication agent.

### Machine Learning Models

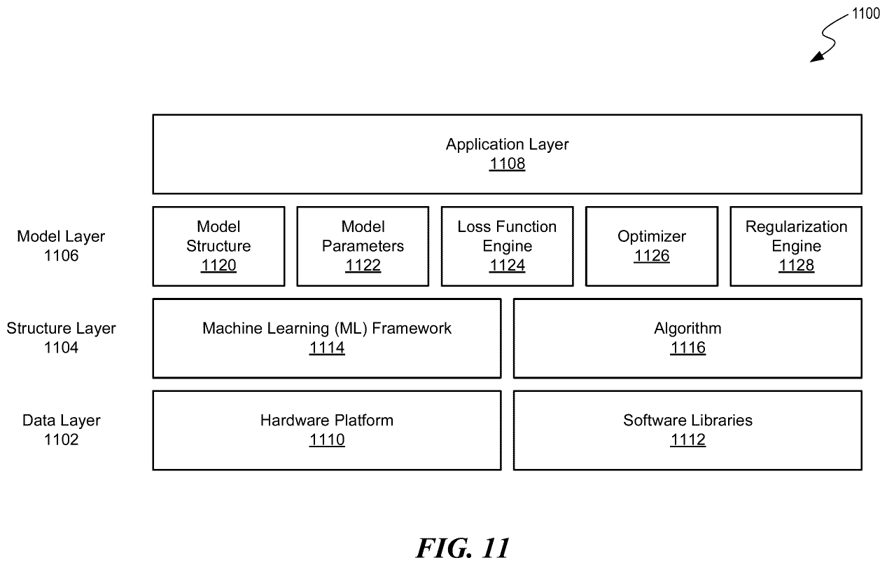

FIG. 11 illustrates a layered architecture of an artificial intelligence (AI) system 1100 that can implement the ML models of the interactive signal processing system 200 of FIG. 2, in accordance with some implementations of the present technology. Example ML models can include the models executed by the machine learning (ML) models 250. Accordingly, the machine learning (ML) 250 can include one or more components of the AI system 1100.

As shown, the AI system 1100 can include a set of layers, which conceptually organize elements within an example network topology for the AI system's architecture to implement a particular AI model. Generally, an AI model is a computer-executable program implemented by the AI system 1100 that analyses data to make predictions. Information can pass through each layer of the AI system 1100 to generate outputs for the AI model. The layers can include a data layer 1102, a structure layer 1104, a model layer 1106, and an application layer 1108. The algorithm 1116 of the structure layer 1104 and the model structure 1120 and model parameters 1122 of the model layer 1106 together form an example AI model. The optimizer 1126, loss function engine 1124, and regularization engine 1128 work to refine and optimize the AI model, and the data layer 1102 provides resources and support for application of the AI model by the application layer 1108.

The data layer 1102 acts as the foundation of the AI system 1100 by preparing data for the AI model. As shown, the data layer 1102 can include two sub-layers: a hardware platform 1110 and one or more software libraries 1112. The hardware platform 1110 can be designed to perform operations for the AI model and include computing resources for storage, memory, logic and networking, such as the resources described in relation to FIGS. 4 and 6. The hardware platform 1110 can process amounts of data using one or more servers. The servers can perform backend operations such as matrix calculations, parallel calculations, machine learning (ML) training, and the like. Examples of servers used by the hardware platform 1110 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors, such as application specific integrated circuits (ASIC). GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 1110 can include computing resources, (e.g., servers, memory, etc.) offered by a cloud services provider. The hardware platform 1110 can also include computer memory for storing data about the AI model, application of the AI model, and training data for the AI model. The computer memory can be a form of random-access memory (RAM), such as dynamic RAM, static RAM, and non-volatile RAM.

The software libraries 1112 can be thought of suites of data and programming code, including executables, used to control the computing resources of the hardware platform 1110. The programming code can include low-level primitives (e.g., fundamental language elements) that form the foundation of one or more low-level programming languages, such that servers of the hardware platform 1110 can use the low-level primitives to carry out specific operations. The low-level programming languages do not require much, if any, abstraction from a computing resource's instruction set architecture, allowing them to run quickly with a small memory footprint. Examples of software libraries 1112 that can be included in the AI system 1100 include INTEL Math Kernel Library, NVIDIA cuDNN, EIGEN, and OpenBLAS.

The structure layer 1104 can include an ML framework 1114 and an algorithm 1116. The ML framework 1114 can be thought of as an interface, library, or tool that allows users to build and deploy the AI model. The ML framework 1114 can include an open-source library, an application programming interface (API), a gradient-boosting library, an ensemble method, and/or a deep learning toolkit that work with the layers of the AI system facilitate development of the AI model. For example, the ML framework 1114 can distribute processes for application or training of the AI model across multiple resources in the hardware platform 1110. The ML framework 1114 can also include a set of pre-built components that have the functionality to implement and train the AI model and allow users to use pre-built functions and classes to construct and train the AI model. Thus, the ML framework 1114 can be used to facilitate data engineering, development, hyperparameter tuning, testing, and training for the AI model. Examples of ML frameworks 1114 that can be used in the AI system 1100 include TENSORFLOW, PYTORCH, SCIKIT-LEARN, KERAS, LightGBM, RANDOM FOREST, and AMAZON WEB SERVICES.

The algorithm 1116 can be an organized set of computer-executable operations used to generate output data from a set of input data and can be described using pseudocode. The algorithm 1116 can include complex code that allows the computing resources to learn from new input data and create new/modified outputs based on what was learned. In some implementations, the algorithm 1116 can build the AI model through being trained while running computing resources of the hardware platform 1110. This training allows the algorithm 1116 to make predictions or decisions without being explicitly programmed to do so. Once trained, the algorithm 1116 can run at the computing resources as part of the AI model to make predictions or decisions, improve computing resource performance, or perform tasks. The algorithm 1116 can be trained using supervised learning, unsupervised learning, semi-supervised learning, and/or reinforcement learning.

Using supervised learning, the algorithm 1116 can be trained to learn patterns (e.g., map input data to output data) based on labeled training data. The training data may be labeled by an external user or operator. For instance, a user may collect a set of training data, such as by capturing data from sensors, images from a camera, outputs from a model, and the like. Furthermore, training data can include pre-processed data generated by various engines of the interactive signal processing system 200 described in relation to FIG. 2. The user may label the training data based on one or more classes and trains the AI model by inputting the training data to the algorithm 1116. The algorithm determines how to label the new data based on the labeled training data. The user can facilitate collection, labeling, and/or input via the ML framework 1114. In some instances, the user may convert the training data to a set of feature vectors for input to the algorithm 1116. Once trained, the user can test the algorithm 1116 on new data to determine if the algorithm 1116 is predicting accurate labels for the new data. For example, the user can use cross-validation methods to test the accuracy of the algorithm 1116 and retrain the algorithm 1116 on new training data if the results of the cross-validation are below an accuracy threshold.

Supervised learning can involve classification and/or regression. Classification techniques involve teaching the algorithm 1116 to identify a category of new observations based on training data and are used when input data for the algorithm 1116 is discrete. Said differently, when learning through classification techniques, the algorithm 1116 receives training data labeled with categories (e.g., classes) and determines how features observed in the training data (e.g., various claim elements, policy identifiers, tokens extracted from unstructured data) relate to the categories (e.g., risk propensity categories, claim leakage propensity categories, complaint propensity categories). Once trained, the algorithm 1116 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques involve estimating relationships between independent and dependent variables and are used when input data to the algorithm 1116 is continuous. Regression techniques can be used to train the algorithm 1116 to predict or forecast relationships between variables. To train the algorithm 1116 using regression techniques, a user can select a regression method for estimating the parameters of the model. The user collects and labels training data that is input to the algorithm 1116 such that the algorithm 1116 is trained to understand the relationship between data features and the dependent variable(s). Once trained, the algorithm 1116 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill-in missing data for machine-learning based pre-processing operations.

Under unsupervised learning, the algorithm 1116 learns patterns from unlabeled training data. In particular, the algorithm 1116 is trained to learn hidden patterns and insights of input data, which can be used for data exploration or for generating new data. Here, the algorithm 1116 does not have a predefined output, unlike the labels output when the algorithm 1116 is trained using supervised learning. Said another way, unsupervised learning is used to train the algorithm 1116 to find an underlying structure of a set of data, group the data according to similarities, and represent that set of data in a compressed format.

A few techniques can be used in supervised learning: clustering, anomaly detection, and techniques for learning latent variable models. Clustering techniques involve grouping data into different clusters that include similar data, such that other clusters contain dissimilar data. For example, during clustering, data with possible similarities remain in a group that has less or no similarities to another group. Examples of clustering techniques density-based methods, hierarchical based methods, partitioning methods, and grid-based methods. In one example, the algorithm 1116 may be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 1116 may be trained to be an Isolation Forest, local outlier factor (LOF) algorithm, or K-nearest neighbor (k-NN) algorithm. Latent variable techniques involve relating observable variables to a set of latent variables. These techniques assume that the observable variables are the result of an individual's position on the latent variables and that the observable variables have nothing in common after controlling for the latent variables. Examples of latent variable techniques that may be used by the algorithm 1116 include factor analysis, item response theory, latent profile analysis, and latent class analysis.

The model layer 1106 implements the AI model using data from the data layer and the algorithm 1116 and ML framework 1114 from the structure layer 1104, thus enabling decision-making capabilities of the AI system 1100. The model layer 1106 includes a model structure 1120, model parameters 1122, a loss function engine 1124, an optimizer 1126, and a regularization engine 1128.

The model structure 1120 describes the architecture of the AI model of the AI system 1100. The model structure 1120 defines the complexity of the pattern/relationship that the AI model expresses. Examples of structures that can be used as the model structure 1120 include decision trees, support vector machines, regression analyses, Bayesian networks, Gaussian processes, genetic algorithms, and artificial neural networks (or, simply, neural networks). The model structure 1120 can include a number of structure layers, a number of nodes (or neurons) at each structure layer, and activation functions of each node. Each node's activation function defines how to node converts data received to data output. The structure layers may include an input layer of nodes that receive input data, an output layer of nodes that produce output data. The model structure 1120 may include one or more hidden layers of nodes between the input and output layers. The model structure 1120 can be an Artificial Neural Network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 1122 represent the relationships learned during training and can be used to make predictions and decisions based on input data. The model parameters 1122 can weight and bias the nodes and connections of the model structure 1120. For instance, when the model structure 1120 is a neural network, the model parameters 1122 can weight and bias the nodes in each layer of the neural networks, such that the weights determine the strength of the nodes and the biases determine the thresholds for the activation functions of each node. The model parameters 1122, in conjunction with the activation functions of the nodes, determine how input data is transformed into desired outputs. The model parameters 1122 can be determined and/or altered during training of the algorithm 1116.

The loss function engine 1124 can determine a loss function, which is a metric used to evaluate the AI model's performance during training. For instance, the loss function engine 1124 can measure the difference between a predicted output of the AI model and the actual output of the AI model and is used to guide optimization of the AI model during training to minimize the loss function. The loss function may be presented via the ML framework 1114, such that a user can determine whether to retrain or otherwise alter the algorithm 1116 if the loss function is over a threshold. In some instances, the algorithm 1116 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 1126 adjusts the model parameters 1122 to minimize the loss function during training of the algorithm 1116. In other words, the optimizer 1126 uses the loss function generated by the loss function engine 1124 as a guide to determine what model parameters lead to the most accurate AI model. Examples of optimizers include Gradient Descent (GD), Adaptive Gradient Algorithm (AdaGrad), Adaptive Moment Estimation (Adam), Root Mean Square Propagation (RMSprop), Radial Base Function (RBF) and Limited-memory BFGS (L-BFGS). The type of optimizer 1126 used may be determined based on the type of model structure 1120 and the size of data and the computing resources available in the data layer 1102.

The regularization engine 1128 executes regularization operations. Regularization is a technique that prevents over- and under-fitting of the AI model. Overfitting occurs when the algorithm 1116 is overly complex and too adapted to the training data, which can result in poor performance of the AI model. Underfitting occurs when the algorithm 1116 is unable to recognize even basic patterns from the training data such that it cannot perform well on training data or on validation data. The optimizer 1126 can apply one or more regularization techniques to fit the algorithm 1116 to the training data properly, which helps constraint the resulting AI model and improves its ability for generalized application. Examples of regularization techniques include lasso (L1) regularization, ridge (L2) regularization, and elastic (L1 and L2 regularization).

The application layer 1108 describes how the AI system 1100 is used to solve problem or perform tasks. In an example implementation, the application layer 1108 can be communicatively coupled (e.g., display application data, receive user input, and/or the like) to an interactable user interface of the interactive signal processing system 200 of FIG. 2.

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. Training data may be annotated with ground truth labels (e.g., each data entry in the training dataset may be paired with a label), or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (also referred to as update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publically-available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to a ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses LLMs.

A language model may use a neural network (typically a DNN) to perform natural language processing (NLP) tasks. A language model may be trained to model how words relate to each other in a textual sequence, based on probabilities. A language model may contain hundreds of thousands of learned parameters or in the case of a large language model (LLM) may contain millions or billions of learned parameters or more. As non-limiting examples, a language model can generate text, translate text, summarize text, answer questions, write code (e.g., Phyton, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

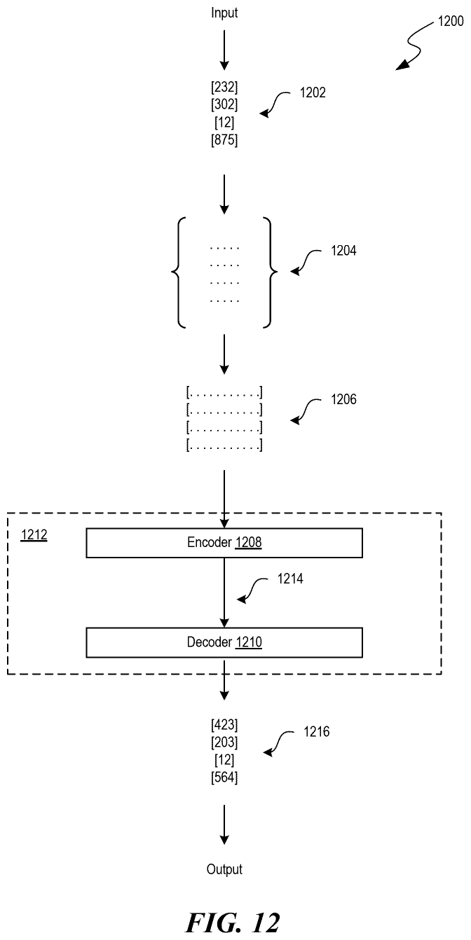

FIG. 12 is a block diagram of an example transformer 1212 that can implement aspects of the present technology. A transformer is a type of neural network architecture that uses self-attention mechanisms to generate predicted output based on input data that has some sequential meaning (i.e., the order of the input data is meaningful, which is the case for most text input). Self-attention is a mechanism that relates different positions of a single sequence to compute a representation of the same sequence. Although transformer-based language models are described herein, it should be understood that the present disclosure may be applicable to any machine learning (ML)-based language model, including language models based on other neural network architectures such as recurrent neural network (RNN)-based language models.

The transformer 1212 includes an encoder 1208 (which can comprise one or more encoder layers/blocks connected in series) and a decoder 1210 (which can comprise one or more decoder layers/blocks connected in series). Generally, the encoder 1208 and the decoder 1210 each include a plurality of neural network layers, at least one of which can be a self-attention layer. The parameters of the neural network layers can be referred to as the parameters of the language model.

The transformer 1212 can be trained to perform certain functions on a natural language input. For example, the functions include summarizing existing content, brainstorming ideas, writing a rough draft, fixing spelling and grammar, and translating content. Summarizing can include extracting key points from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some embodiments, the transformer 1212 is trained to perform certain functions on other input formats than natural language input. For example, the input can include objects, images, audio content, or video content, or a combination thereof.

The transformer 1212 can be trained on a text corpus that is labeled (e.g., annotated to indicate verbs, nouns) or unlabeled. Large language models (LLMs) can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input). FIG. 12 illustrates an example of how the transformer 1212 can process textual input data. Input to a language model (whether transformer-based or otherwise) typically is in the form of natural language that can be parsed into tokens. It should be appreciated that the term “token” in the context of language models and Natural Language Processing (NLP) has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some examples, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 12, a short sequence of tokens 1202 corresponding to the input text is illustrated as input to the transformer 1212. Tokenization of the text sequence into the tokens 1202 can be performed by some pre-processing tokenization module such as, for example, a byte-pair encoding tokenizer (the “pre” referring to the tokenization occurring prior to the processing of the tokenized input by the LLM), which is not shown in FIG. 12 for simplicity. In general, the token sequence that is inputted to the transformer 1212 can be of any length up to a maximum length defined based on the dimensions of the transformer 1212. Each token 1202 in the token sequence is converted into an embedding vector 1206 (also referred to simply as an embedding 1206). An embedding 1206 is a learned numerical representation (such as, for example, a vector) of a token that captures some semantic meaning of the text segment represented by the token 1202. The embedding 1206 represents the text segment corresponding to the token 1202 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 1206 corresponding to the “write” token will be closer to another embedding corresponding to the “jot down” token in the vector space as compared to the distance between the embedding 1206 corresponding to the “write” token and another embedding corresponding to the “summary” token.

The vector space can be defined by the dimensions and values of the embedding vectors. Various techniques can be used to convert a token 1202 to an embedding 1206. For example, another trained ML model can be used to convert the token 1202 into an embedding 1206. In particular, another trained ML model can be used to convert the token 1202 into an embedding 1206 in a way that encodes additional information into the embedding 1206 (e.g., a trained ML model can encode positional information about the position of the token 1202 in the text sequence into the embedding 1206). In some examples, the numerical value of the token 1202 can be used to look up the corresponding embedding in an embedding matrix 1204 (which can be learned during training of the transformer 1212).

The generated embeddings 1206 are input into the encoder 1208. The encoder 1208 serves to encode the embeddings 1206 into feature vectors 1214 that represent the latent features of the embeddings 1206. The encoder 1208 can encode positional information (i.e., information about the sequence of the input) in the feature vectors 1214. The feature vectors 1214 can have very high dimensionality (e.g., on the order of thousands or tens of thousands), with each element in a feature vector 1214 corresponding to a respective feature. The numerical weight of each element in a feature vector 1214 represents the importance of the corresponding feature. The space of all possible feature vectors 1214 that can be generated by the encoder 1208 can be referred to as the latent space or feature space.

Conceptually, the decoder 1210 is designed to map the features represented by the feature vectors 1214 into meaningful output, which can depend on the task that was assigned to the transformer 1212. For example, if the transformer 1212 is used for a translation task, the decoder 1210 can map the feature vectors 1214 into text output in a target language different from the language of the original tokens 1202. Generally, in a generative language model, the decoder 1210 serves to decode the feature vectors 1214 into a sequence of tokens. The decoder 1210 can generate output tokens 1216 one by one. Each output token 1216 can be fed back as input to the decoder 1210 in order to generate the next output token 1216. By feeding back the generated output and applying self-attention, the decoder 1210 is able to generate a sequence of output tokens 1216 that has sequential meaning (e.g., the resulting output text sequence is understandable as a sentence and obeys grammatical rules). The decoder 1210 can generate output tokens 1216 until a special [EOT] token (indicating the end of the text) is generated. The resulting sequence of output tokens 1216 can then be converted to a text sequence in post-processing. For example, each output token 1216 can be an integer number that corresponds to a vocabulary index. By looking up the text segment using the vocabulary index, the text segment corresponding to each output token 1216 can be retrieved, the text segments can be concatenated together, and the final output text sequence can be obtained.

In some examples, the input provided to the transformer 1212 includes instructions to perform a function on an existing text. In some examples, the input provided to the transformer includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text. For example, the input can include the question “What is the weather like in Australia?” and the output can include a description of the weather in Australia.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as, for example, the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via its API. As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Example Computer System

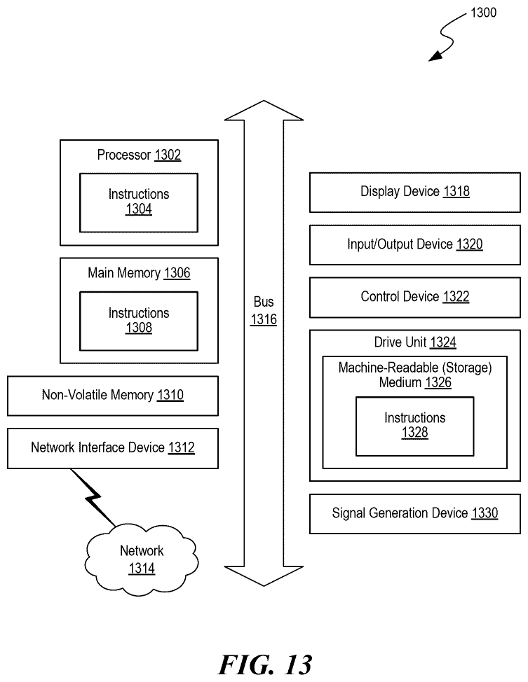

FIG. 13 is a block diagram that illustrates an example of a computer system 1300 in which at least some operations described herein can be implemented. As shown, the computer system 1300 can include: one or more processors 1302, main memory 1306, non-volatile memory 1310, a network interface device 1312, a video display device 1318, an input/output device 1320, a control device 1322 (e.g., keyboard and pointing device), a drive unit 1324 that includes a machine-readable (storage) medium 1326, and a signal generation device 1330 that are communicatively connected to a bus 1316. The bus 1316 represents one or more physical buses and/or point-to-point connections that are connected by appropriate bridges, adapters, or controllers. Various common components (e.g., cache memory) are omitted from FIG. 13 for brevity. Instead, the computer system 1300 is intended to illustrate a hardware device on which components illustrated or described relative to the examples of the figures and any other components described in this specification can be implemented.

The computer system 1300 can take any suitable physical form. For example, the computing system 1300 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 1300. In some implementations, the computer system 1300 can be an embedded computer system, a system-on-chip (SOC), a single-board computer system (SBC), or a distributed system such as a mesh of computer systems, or it can include one or more cloud components in one or more networks. Where appropriate, one or more computer systems 1300 can perform operations in real time, in near real time, or in batch mode.

The network interface device 1312 enables the computing system 1300 to mediate data in a network 1314 with an entity that is external to the computing system 1300 through any communication protocol supported by the computing system 1300 and the external entity. Examples of the network interface device 1312 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 1306, non-volatile memory 1310, machine-readable medium 1326) can be local, remote, or distributed. Although shown as a single medium, the machine-readable medium 1326 can include multiple media (e.g., a centralized/distributed database and/or associated caches and servers) that store one or more sets of instructions 1328. The machine-readable medium 1326 can include any medium that is capable of storing, encoding, or carrying a set of instructions for execution by the computing system 1300. The machine-readable medium 1326 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 1310, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1304, 1308, 1328) set at various times in various memory and storage devices in computing device(s). When read and executed by the processor 1302, the instruction(s) cause the computing system 1300 to perform operations to execute elements involving the various aspects of the disclosure.

### Further Examples

A computer-implemented method performed by an interactive signal processing system can include displaying, at a user interface, at least one seed video associated with a geographic location and a set of actionable elements linked to the at least one seed video. The method can include determining, from the user interface, a set of detected user actions during the display of the at least one seed video, each detected user action including: (1) a subset of invoked actionable elements linked to the at least one seed video, and (2) a set of action characteristics that represent contextual parameters associated with the subset of invoked actionable elements. The method can include generating, using the subset of invoked actionable elements and the set of action characteristics, a set of user interaction vectors for the set of detected user actions, wherein each user interaction vector corresponds to at least one detected user action, and wherein each user interaction vector includes one or more affinity metrics indicating strength of user engagement with the at least one seed video of the geographic location. The method can include determining, using a machine learning model, a user preference vector based on the set of user interaction vectors, wherein the user preference vector includes dynamic preference weights for one or more characteristic attributes of geographic locations. The method can include creating an ordered sequence of location placeholders for user selected geographic locations, each location placeholder including a set of required characteristic attributes of geographic locations. The method can include identifying, from a remote database, a set of candidate geographic objects, each candidate geographic object including: (1) an accessible geographic location near the geographic location of the at least one seed video, and (2) a set of characteristic attributes of the accessible geographic location. The method can include selecting, using the user preference vector, a set of recommended geographic locations from the set of candidate geographic objects, wherein each recommended geographic location corresponds to a location placeholder in the ordered sequence of location placeholders, and wherein each recommended geographic location satisfies the set of required characteristic attributes of the corresponding location placeholder.

In some implementations, the set of user interaction vectors is a first set of user interaction vectors, and the method can further include determining, from the user interface, a set of indirect user actions during the display of the at least one seed video, each indirect user action including: (1) a subset of actionable elements linked to the at least one seed video not invoked at the user interface, and (2) a second set of action characteristics that represent contextual parameters associated with the subset of actionable elements not invoked at the user interface. The method can include generating, using the subset of actionable elements not invoked at the user interface and the second set of action characteristics, a second set of user interaction vectors for the set of indirect user actions. The method can include determining, using the machine learning model, a second user preference vector based on the first and the second set of user interaction vectors. The method can include selecting, using the second user preference vector, a second set of recommended geographic locations from the set of candidate geographic objects.

In some implementations, the set of user interaction vectors is a first set of user interaction vectors, and the method can further include displaying, at the user interface, an interactive geographic object including at least one recommended geographic location that corresponds to a select location placeholder from the ordered sequence of location placeholders. The method can include determining, from the user interface, a second set of detected user actions during the display of the interactive geographic object, each detected user action including a second set of invoked actionable elements linked to the displayed interactive geographic object, wherein the second set of invoked actionable elements includes an option for assigning the at least one recommended geographic location to the select location placeholder. The method can include responsive to a user selection of the option for assigning the at least one recommended geographic location to the select location placeholder, generating a second set of user interaction vectors for the second set of detected user actions using the second set of invoked actionable elements, wherein each user interaction vector includes one or more affinity metrics indicating strength of user engagement with the interactive geographic object. The method can include determining, using the machine learning model, a second user preference vector based on the first and the second set of user interaction vectors. The method can include selecting, using the second user preference vector, a second set of recommended geographic locations from the set of candidate geographic objects.

In some implementations, the user preference vector is a first user preference vector for a first user, and the method can be further include accessing, from a remote database, a second user preference vector for a second user that is associated with the first user, the at least one seed video, or both. The method can include determining, using the machine learning model, a third user preference vector for the first user based on the first and the second user preference vectors. The method can include selecting, using the third user preference vector, a second set of recommended geographic locations from the set of candidate geographic objects.

In some implementations, the method can include responsive to at least one location placeholder from the order of location placeholders not associated to a recommended geographic location from the set of recommended geographic locations, (1) accessing at least one set of geographic locations selected by another user, and (2) adding one or more geographic objects corresponding to geographic locations from the at least one set of geographic locations created by another user to the set of candidate geographic objects.

In some implementations, the method can include generating, using the machine learning model, a geographic reference vector based on the set of characteristic attributes of the accessible geographic location for at least one candidate geographic object. The method can include calculating, via comparison of the geographic reference vector and the user preference vector, a similarity score that represents user compatibility with the accessible geographic location for the at least one candidate object. The method can include responsive to the similarity score exceeding a similarity threshold, adding the accessible geographic location of the at least one candidate geographic object to the set of recommended geographic locations.

In some implementations, the method can include accessing, from a remote database, a mapping of geographic identifiers and available geographic objects, each geographic identifier encoding information for a specified geographic location. The method can include identifying a source geographic identifier that includes a nearest encoded geographic location for the geographic location of the at least one seed video. The method can include determining a set of proximate geographic identifiers that include an encoded geographic location within a specified distance from the nearest encoded geographic location of the source geographic identifier. The method can include selecting, via the mapping, a set of geographic objects that maps to the set of proximate geographic identifiers.

In some implementations, the set of detected user actions during the display of the at least one seed video can include a start of video playback, a pause of video playback, a completed view of a specified video segment, a review of a specified video playback, an alteration of video playback speed, a rating of seed video, a submission of a publicly accessible message, a sharing of seed video, or any combination thereof.

In some implementations, the set of action characteristics that represent contextual parameters associated with the subset of invoked actionable elements can include a timestamp of action invocation, a duration of action invocation, a frequency of action invocation, a user activity related to action invocation, or any combination thereof.

In some implementations, the set of required characteristic attributes of geographic locations can include an environment type, an accessible venue, an accessible event, a point of interest (POI), an available transportation mode, a time interval, a calendar date, an expense range, a quality rating, an applicable filter category, a viewable image of geographic location, a contact information, an external redirection link, or any combination thereof.

A computer-implemented method performed by an interactive signal processing system can include monitoring, via a real-time application programming interface (API), an ordered sequence of interactive signals transmitted between a user and a communication agent, each interactive signal including a set of content features that correspond to a target geographic location. The method can include generating, using the set of content features that correspond to the target geographic location, a set of user interaction vectors for the ordered sequence of interactive signals, each user interaction vector including one or more affinity metrics indicating strength of user engagement with the communication agent. The method can include determining, using a machine learning model, a user preference vector based on the set of user interaction vectors, the user preference vector including dynamic preference weights for one or more characteristic attributes of geographic locations. The method can include selecting, from a stored user profile, at least one ordered sequence of prior interaction signals transmitted between the user and the communication agent using the user preference vector, each prior interaction signal including content features that correspond to a prior geographic location. The method can include prompting, using a combination of the ordered sequence of interactive signals and the at least one ordered sequence of prior interaction signals, a generative machine learning model to identify a set of candidate points of interest located near the target geographic location. The method can include displaying, at a user interface of the user, the identified set of candidate points of interest via a user interactive component associated with the communication agent. The method can include responsive to user selection of a target point of interest from the displayed set of candidate points of interest, automatically assigning the target point of interest to an available placeholder of an ordered sequence of user selected points of interest.

In some implementations, the method can include accessing, from a stored user profile, a set of recorded ordered sequences of prior interaction signals transmitted between the user and the communication agent, wherein each recorded ordered sequence of prior interaction signals includes a comparable embedding vector representative of content features for the prior interaction signals. The method can include responsive to comparison of the embedding vector of a recorded ordered sequence of prior interaction signals and the user preference vector exceeding a similarity threshold, adding the recorded ordered sequence of prior interaction signals to the at least one ordered sequence of prior interaction signals. identifying, via comparison of embedding vectors of the set of ordered sequences and the user preference vector, at least one ordered sequence of prior interaction signals.

In some implementations, the user preference vector is a first user preference vector of a first user, and the method can include identifying, from the stored user profile of the first user, a second user associated with a second user preference vector. The method can include selecting, from a stored user profile of the second user, at least one ordered sequence of prior interaction signals transmitted between the second user and the communication agent using the second user preference vector. The method can include prompting, using a combination of the ordered sequence of interactive signals and the at least one ordered sequence of prior interaction signals transmitted between the second user and the communication agent, the generative machine learning model to identify a second set of candidate points of interest located near the target geographic location.

In some implementations, the method can include responsive to receiving a termination condition for the ordered sequence of interactive signals transmitted between the user and the communication agent, generating, using a machine learning model, a comparable embedding vector representative of content features of the interaction signals.

In some implementations, the method can include retrieving a declarative data structure including: (1) at least one contextual information associated with the target geographic location, and (2) a set of points of interest previously selected by the user. The method can include prompting, using a combination of the ordered sequence of interactive signals and contents of the declarative data structure, the generative machine learning model to identify a second set of candidate points of interest located near the target geographic location.

In some implementations, the method can include generating, using the combined sequences of interactive signals and the user preference vector, a search configuration record that corresponds to the set of candidate points of interest. The method can include accessing, from a remote database, a cache mapping of prior search configuration records to sets of prior candidate points of interest, each prior search configuration record corresponding to a set of prior candidate points of interest. The method can include responsive to at least one prior search configuration record from the cache mapping including content similarities to the search configuration record, adding the set of prior candidate points of interest of the at least one prior search configuration record to the set of candidate points of interest.

In some implementations, the method can include prompting, using the set of candidate points of interest, the generative machine learning model to create a set of interactive user actions for extending the ordered sequence of interactive signals between the user and the communication agent. The method can include displaying, at the user interface of the user, the set of interactive user actions alongside the identified set of candidate points of interest. The method can include responsive to user invocation of at least one interactive user action from the displayed set of interactive user actions, automatically assigning the at least one interactive user action to the ordered sequence of interactive signals between the user and the communication agent.

In some implementations, the set of interactive signals between the user and the communication agent includes transmission of a human-readable alphanumeric string, an image, an audio signal, a video, a route to an external resource, a scrolling action, a submission of a message, a response to a specified message, an addition of supplementary documents, a selection of a point of interest, a prioritization of a point of interest, or a combination thereof.

In some implementations, the set of content features that correspond to the target geographic location includes a location description, an environment description, an event description, an information request, an additional resource corresponding to the geographic location, an image associated with the geographic location, an audio associated with the geographic location, or a combination thereof.

### Remarks

The terms “example,” “embodiment,” and “implementation” are used interchangeably. For example, references to “one example” or “an example” in the disclosure can be, but not necessarily are, references to the same implementation. The method can include and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements. The method can include the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. An interactive signal processing system comprising:
at least one hardware processor; and
at least one non-transitory memory carrying instructions that, when executed by the at least one hardware processor, cause the system to perform operations comprising:
configure for display, via at least one user interface, at least one seed video associated with a geographic location and a set of actionable elements linked to the at least one seed video;
determine, via the at least one user interface, a set of detected user actions during the display of the at least one seed video, each detected user action comprising:
(1) a subset of invoked actionable elements linked to the at least one seed video, and
(2) a set of action characteristics that represent contextual parameters associated with the subset of invoked actionable elements;
generate, using the subset of invoked actionable elements and the set of action characteristics, a set of user interaction vectors for the set of detected user actions,
wherein each user interaction vector corresponds to at least one detected user action, and
wherein each user interaction vector comprises one or more affinity metrics indicating strength of user engagement with the at least one seed video of the geographic location;
determine, using a machine learning model, a user preference vector based on the set of user interaction vectors,
wherein the user preference vector comprises dynamic preference weights for one or more characteristic attributes of geographic locations;
create an ordered sequence of location placeholders for user selected geographic locations, each location placeholder comprising a set of required characteristic attributes of geographic locations;
identify, from a remote database, a set of candidate geographic objects, each candidate geographic object comprising:
(1) an accessible geographic location near the geographic location of the at least one seed video, and
(2) a set of characteristic attributes of the accessible geographic location; and
select, using the user preference vector, a set of recommended geographic locations from the set of candidate geographic objects,
wherein each recommended geographic location corresponds to a location placeholder in the ordered sequence of location placeholders, and
wherein each recommended geographic location satisfies the set of required characteristic attributes of the corresponding location placeholder.

2. The system of claim 1, wherein the set of user interaction vectors is a first set of user interaction vectors, and wherein the system is further caused to:
determine, via the at least one user interface, a set of indirect user actions during the display of the at least one seed video, each indirect user action comprising:
(1) a subset of actionable elements linked to the at least one seed video not invoked via the at least one user interface, and
(2) a second set of action characteristics that represent contextual parameters associated with the subset of actionable elements not invoked via the at least one user interface;
generate, using the subset of actionable elements not invoked via the at least one user interface and the second set of action characteristics, a second set of user interaction vectors for the set of indirect user actions; and
determine, using the machine learning model, a second user preference vector based on the first and the second set of user interaction vectors; and
select, using the second user preference vector, a second set of recommended geographic locations from the set of candidate geographic objects.

3. The system of claim 1, wherein the set of user interaction vectors is a first set of user interaction vectors, and wherein the system is further caused to:
configure for display, via the at least one user interface, an interactive geographic object comprising at least one recommended geographic location that corresponds to a select location placeholder from the ordered sequence of location placeholders;
determine, via the at least one user interface, a second set of detected user actions during the display of the interactive geographic object, each detected user action comprising a second set of invoked actionable elements linked to the displayed interactive geographic object,
wherein the second set of invoked actionable elements comprises an option for assigning the at least one recommended geographic location to the select location placeholder;
responsive to a user selection of the option for assigning the at least one recommended geographic location to the select location placeholder, generate a second set of user interaction vectors for the second set of detected user actions using the second set of invoked actionable elements,
wherein each user interaction vector comprises one or more affinity metrics indicating strength of user engagement with the interactive geographic object;
determine, using the machine learning model, a second user preference vector based on the first and the second set of user interaction vectors; and
select, using the second user preference vector, a second set of recommended geographic locations from the set of candidate geographic objects.

4. The system of claim 1, wherein the user preference vector is a first user preference vector for a first user, and wherein the system is further caused to:
access, from a remote database, a second user preference vector for a second user that is associated with the first user, the at least one seed video, or both;
determine, using the machine learning model, a third user preference vector for the first user based on the first and the second user preference vectors; and
select, using the third user preference vector, a second set of recommended geographic locations from the set of candidate geographic objects.

5. The system of claim 3 further caused to:
responsive to at least one location placeholder from the order of location placeholders not associated to a recommended geographic location from the set of recommended geographic locations,
(1) accessing at least one set of geographic locations selected by another user, and
(2) adding one or more geographic objects corresponding to geographic locations from the at least one set of geographic locations created by another user to the set of candidate geographic objects.

6. The system of claim 1 further caused to:
generate, using the machine learning model, a geographic reference vector based on the set of characteristic attributes of the accessible geographic location for at least one candidate geographic object;
calculate, via comparison of the geographic reference vector and the user preference vector, a similarity score that represents user compatibility with the accessible geographic location for the at least one candidate object; and
responsive to the similarity score exceeding a similarity threshold, add the accessible geographic location of the at least one candidate geographic object to the set of recommended geographic locations.

7. The system of claim 1 further caused to:
access, from a remote database, a mapping of geographic identifiers and available geographic objects, each geographic identifier encoding information for a specified geographic location;
identify a source geographic identifier that comprises a nearest encoded geographic location for the geographic location of the at least one seed video;
determine a set of proximate geographic identifiers that comprise an encoded geographic location within a specified distance from the nearest encoded geographic location of the source geographic identifier; and
select, via the mapping, a set of geographic objects that maps to the set of proximate geographic identifiers.

8. The system of claim 1, wherein the set of detected user actions during the display of the at least one seed video includes a start of video playback, a pause of video playback, a completed view of a specified video segment, a review of a specified video playback, an alteration of video playback speed, a rating of seed video, a submission of a publicly accessible message, a sharing of seed video, or any combination thereof.

9. The system of claim 1, wherein the set of action characteristics that represent contextual parameters associated with the subset of invoked actionable elements includes a timestamp of action invocation, a duration of action invocation, a frequency of action invocation, a user activity related to action invocation, or any combination thereof.

10. The system of claim 1, wherein the set of required characteristic attributes of geographic locations includes an environment type, an accessible venue, an accessible event, a point of interest (POI), an available transportation mode, a time interval, a calendar date, an expense range, a quality rating, an applicable filter category, a viewable image of geographic location, a contact information, an external redirection link, or any combination thereof.

11. A non-transitory, computer-readable storage medium comprising instructions recorded thereon, wherein the instructions, when executed by at least one data processor of a system, cause the system to:
configure for display, via at least one user interface, at least one seed video associated with a geographic location and a set of actionable elements linked to the at least one seed video;
determine, via the at least one user interface, a set of detected user actions during the display of the at least one seed video, each detected user action comprising:
(1) a subset of invoked actionable elements linked to the at least one seed video, and
(2) a set of action characteristics that represent contextual parameters associated with the subset of invoked actionable elements;
generate, using the subset of invoked actionable elements and the set of action characteristics, a set of user interaction vectors for the set of detected user actions,
wherein each user interaction vector corresponds to at least one detected user action, and
wherein each user interaction vector comprises one or more affinity metrics indicating strength of user engagement with the at least one seed video of the geographic location;
determine, using a machine learning model, a user preference vector based on the set of user interaction vectors,
wherein the user preference vector comprises dynamic preference weights for one or more characteristic attributes of geographic locations;
create an ordered sequence of location placeholders for user selected geographic locations, each location placeholder comprising a set of required characteristic attributes of geographic locations;
identify, from a remote database, a set of candidate geographic objects, each candidate geographic object comprising:
(1) an accessible geographic location near the geographic location of the at least one seed video, and
(2) a set of characteristic attributes of the accessible geographic location; and
select, using the user preference vector, a set of recommended geographic locations from the set of candidate geographic objects,
wherein each recommended geographic location corresponds to a location placeholder in the ordered sequence of location placeholders, and
wherein each recommended geographic location satisfies the set of required characteristic attributes of the corresponding location placeholder.

12. The non-transitory, computer-readable storage medium of claim 11, wherein the set of user interaction vectors is a first set of user interaction vectors, and wherein the instructions further cause the system to:
determine, via the at least one user interface, a set of indirect user actions during the display of the at least one seed video, each indirect user action comprising:
(1) a subset of actionable elements linked to the at least one seed video not invoked via the at least one user interface, and
(2) a second set of action characteristics that represent contextual parameters associated with the subset of actionable elements not invoked via the at least one user interface;
generate, using the subset of actionable elements not invoked via the at least one user interface and the second set of action characteristics, a second set of user interaction vectors for the set of indirect user actions; and
determine, using the machine learning model, a second user preference vector based on the first and the second set of user interaction vectors; and
select, using the second user preference vector, a second set of recommended geographic locations from the set of candidate geographic objects.

13. The non-transitory, computer-readable storage medium of claim 11, wherein the set of user interaction vectors is a first set of user interaction vectors, and wherein the instructions further cause the system to:
display, via the at least one user interface, an interactive geographic object comprising at least one recommended geographic location that corresponds to a select location placeholder from the ordered sequence of location placeholders;
determine, via the at least one user interface, a second set of detected user actions during the display of the interactive geographic object, each detected user action comprising a second set of invoked actionable elements linked to the displayed interactive geographic object,
wherein the second set of invoked actionable elements comprises an option for assigning the at least one recommended geographic location to the select location placeholder;
responsive to a user selection of the option for assigning the at least one recommended geographic location to the select location placeholder, generate a second set of user interaction vectors for the second set of detected user actions using the second set of invoked actionable elements,
wherein each user interaction vector comprises one or more affinity metrics indicating strength of user engagement with the interactive geographic object;
determine, using the machine learning model, a second user preference vector based on the first and the second set of user interaction vectors; and
select, using the second user preference vector, a second set of recommended geographic locations from the set of candidate geographic objects.

14. The non-transitory, computer-readable storage medium of claim 11, wherein the user preference vector is a first user preference vector for a first user, and wherein the instructions further cause the system to:
access, from a remote database, a second user preference vector for a second user that is associated with the first user, the at least one seed video, or both;
determine, using the machine learning model, a third user preference vector for the first user based on the first and the second user preference vectors; and
select, using the third user preference vector, a second set of recommended geographic locations from the set of candidate geographic objects.

15. The non-transitory, computer-readable storage medium of claim 13, wherein the instructions further cause the system to:
responsive to at least one location placeholder from the order of location placeholders not associated to a recommended geographic location from the set of recommended geographic locations,
(1) accessing at least one set of geographic locations selected by another user, and
(2) adding one or more geographic objects corresponding to geographic locations from the at least one set of geographic locations created by another user to the set of candidate geographic objects.

16. The non-transitory, computer-readable storage medium of claim 11, wherein the instructions further cause the system to:
generate, using the machine learning model, a geographic reference vector based on the set of characteristic attributes of the accessible geographic location for at least one candidate geographic object;
calculate, via comparison of the geographic reference vector and the user preference vector, a similarity score that represents user compatibility with the accessible geographic location for the at least one candidate object; and
responsive to the similarity score exceeding a similarity threshold, add the accessible geographic location of the at least one candidate geographic object to the set of recommended geographic locations.

17. The non-transitory, computer-readable storage medium of claim 11, wherein the instructions further cause the system to:
access, from a remote database, a mapping of geographic identifiers and available geographic objects, each geographic identifier encoding information for a specified geographic location;
identify a source geographic identifier that comprises a nearest encoded geographic location for the geographic location of the at least one seed video;
determine a set of proximate geographic identifiers that comprise an encoded geographic location within a specified distance from the nearest encoded geographic location of the source geographic identifier; and
select, via the mapping, a set of geographic objects that maps to the set of proximate geographic identifiers.

18. A computer-implemented method comprising:
configuring for display, via at least one user interface, at least one seed video associated with a geographic location and a set of actionable elements linked to the at least one seed video;
determining, via the at least one user interface, a set of detected user actions during the display of the at least one seed video, each detected user action comprising a subset of invoked actionable elements linked to the at least one seed video;
generating, using the subset of invoked actionable elements, a set of user interaction vectors for the set of detected user actions,
wherein each user interaction vector comprises one or more affinity metrics indicating strength of user engagement with the at least one seed video of the geographic location;
determining, using a machine learning model, a user preference vector based on the set of user interaction vectors,
wherein the user preference vector comprises dynamic preference weights for one or more characteristic attributes of geographic locations;
creating an ordered sequence of location placeholders for user selected geographic locations, each location placeholder comprising a set of required characteristic attributes of geographic locations;
identifying, from a remote database, a set of candidate geographic objects, each candidate geographic object comprising an accessible geographic location near the geographic location of the at least one seed video; and
selecting, using the user preference vector, a set of recommended geographic locations from the set of candidate geographic objects,
wherein each recommended geographic location corresponds to a location placeholder in the ordered sequence of location placeholders, and
wherein each recommended geographic location satisfies the set of required characteristic attributes of the corresponding location placeholder.

19. The computer-implemented method of claim 18, wherein the set of user interaction vectors is a first set of user interaction vectors, and wherein the method further comprises:
determining, via the at least one user interface, a set of indirect user actions during the display of the at least one seed video, each indirect user action comprising a subset of actionable elements linked to the at least one seed video not invoked via the at least one user interface;
generating, using the subset of actionable elements not invoked via the at least one user interface, a second set of user interaction vectors for the set of indirect user actions; and
determining, using the machine learning model, a second user preference vector based on the first and the second set of user interaction vectors; and
selecting, using the second user preference vector, a second set of recommended geographic locations from the set of candidate geographic objects.

20. The computer-implemented method of claim 18, wherein the set of user interaction vectors is a first set of user interaction vectors, and wherein the method further comprises:
displaying, via the at least one user interface, an interactive geographic object comprising at least one recommended geographic location that corresponds to a select location placeholder from the ordered sequence of location placeholders;
determining, via the at least one user interface, a second set of detected user actions during the display of the interactive geographic object, each detected user action comprising a second set of invoked actionable elements linked to the displayed interactive geographic object;
responsive to a user selection to assign the at least one recommended geographic location to the select location placeholder, generating a second set of user interaction vectors for the second set of detected user actions using the second set of invoked actionable elements;
determining, using the machine learning model, a second user preference vector based on the first and the second set of user interaction vectors; and
selecting, using the second user preference vector, a second set of recommended geographic locations from the set of candidate geographic objects.
